(19) United States
(12) Patent Application Publication
(10) Pub. No.: US 2024/0365444 A1
(43) Pub. Date: Oct. 31, 2024

(54) MONITORING MICROWAVE OVEN LEAKAGE TO ESTIMATE FOOD TEMPERATURE AND FOOD COMPOSITION

(71) Applicant: Ohio State Innovation Foundation, Columbus, OH (US)

(72) Inventors: Avishek BANERJEE, Columbus, OH (US); Kannan SRINIVASAN ATHREYA, Columbus, OH (US)

(21) Appl. No.: 18/577,619

(22) PCT Filed: Jul. 8, 2022
(86) PCT No.: PCT/US2022/036541

§ 371 Date: Jan. 8, 2024

Related U.S. Application Data
(60) Provisional application No. 63/219,470, filed on Jul. 8, 2021.

(51) Int. Cl. H05B 6/70; H05B 6/64; H05B 6/68

(52) U.S. Cl. CPC H05B 6/705; H05B 6/6432; H05B 6/6455; H05B 6/686

(57) ABSTRACT

Described herein are methods for determining the temperature and nutrient content of items heated in a microwave oven. An example method of determining the temperature of the item includes receiving item information; receiving a trained water model; measuring, by an antenna, an emission value from the exterior of the microwave; determining, the power flow into the item based on the trained water model, the item information, and the emission value; and estimating, by the trained water model, a temperature change of the item. An example method of determining the nutrient content includes receiving item information; receiving a trained water model; measuring, by an antenna, an emission value from the exterior of the microwave; determining an emission spectrum from the emission value; and determining, using the emission spectrum, the item information, and the trained water model, a nutrient profile of the item.

### CROSS-REFERENCE TO RELATED APPLICATIONS

This application claims the benefit of U.S. provisional patent application No. 63/219,470, filed on Jul. 8, 2021, and titled “MONITORING MICROWAVE OVEN LEAKAGE TO ESTIMATE FOOD TEMPERATURE AND FOOD COMPOSITION,” the disclosure of which is expressly incorporated herein by reference in its entirety.

### STATEMENT REGARDING FEDERALLY FUNDED RESEARCH

This invention was made with government support under Grant no. DE-NSF 2128567 awarded by the National Science Foundation, Grant no. NSF 2007581 awarded by the National Science Foundation, and Grant no. NSF 2018912, awarded by the National Science Foundation. The government has certain rights in the invention.

### BACKGROUND

Microwave ovens have been widely used in recent years to heat food quickly and efficiently. Users estimate the time to heat the food by prior knowledge or by trial-and-error processes. However, this often results in the food being over-heated or under-heated, destroying the nutrients.

Advancement in intelligent wireless sensing technologies has improved human interaction with various household devices and appliances. With the development of various smart sensing applications like vibration sensing [46,52], pressure sensing [21], electrical sensing [23,37,38], audio sensing [16], temperature sensing [13], camera-based sensing [19,20] has allowed us to monitor and control various indoor appliances to a great extent. However, such techniques require installation of specific hardware sensors for respective applications which becomes costly and requires high maintenance.

Radio-Frequency (RF) sensing has also been widely used in recent works to leverage information from the RF environment. Various RF sensing techniques like WiFi, RF identification (RFID), acoustics, ultra-wideband (UWB) have been widely used to localize and monitor human activities [34, 42, 49] to control various indoor smart devices [29,43,48]. Even though RF sensing provides a low-cost and ubiquitous service compared to hardware sensors, it cannot be directly used for physical measurements like humidity and temperature.

Microwave ovens, also referred to as microwaves, are one of the most commonly used appliances in household and commercial kitchens. Recent research suggested that around 13 million microwave ovens have been shipped in the United States during the year 2019 [8] and around 96% of the households use microwave oven [51]. Microwave ovens heat and cook food using dielectric heating by exposing food to high-frequency electromagnetic radiation which is absorbed by polar molecules (like water) in food. Most modern microwave ovens require users to manually set the cooking or heating time for a particular food. The required time to cook food to a targeted temperature in a microwave oven depends on factors like the orientation of the food, microwave container surface area, dimensions and power output of the microwave oven. It also depends on initial temperature of the food, moisture content, thermal conductivity, and thickness of the food. However, this process requires complex calculations, and it is not feasible for any user to estimate the correct time to heat or cook the food without knowing the above-mentioned factors accurately. Users either estimate the time to heat food by prior knowledge of trial-and-error technique or keep on checking the temperature of the food and repeat the process until the target temperature has reached. This process is highly time-consuming and often results in overheating of the food, destroying nutrients. Research surveys [51] show around 75% of users use the microwave oven more than three times per day. Thus, errors in estimation can have a negative impact on human health in a long run.

Healthy dietary patterns prevent malnutrition, obesity, and other noncommunicable diseases (NCDs), like diabetes, heart disease, stroke, and cancer [9]. However, in recent years, there has been an increasing trend in fast food consumption because of their convenience, low cost, and taste [34A]. More than 50% of young people in the United States of America consume fast food daily [34A]. But most of these foods have high carbohydrate and fat content, which are harmful to human health if consumed for a long period. According to the recent reports of WHO, around 1.5 million deaths have been caused due to diabetes in the year 2019 [11A] and around 650 million people are suffering from obesity [13A] which results in various chronic illness of heart and kidney. Thus, over the past few years, there has been an increasing global awareness to monitor daily food intake among people. For example, those who are more prone to dietary diseases want to monitor their carbohydrate, protein, and fat intakes to have a clear idea of how different nutrients affect their health.

With the improved human lifestyle and standard of living microwave oven has been one of the most commonly used appliances in household and commercial kitchens for cooking and heating food. Recent research suggested that around 96% of the households use microwave ovens [16A, 47A]. However, microwave ovens lack the intelligence to estimate the nutritional value of the food that is being heated or cooked.

The most common way of determining the nutritional value of the food is either from previous knowledge or by checking the labels of food packages. However, such techniques are mostly not accurate for cooking food with complex ingredients, and it is very tedious and time-consuming to check the labels of food every time and calculate the numbers. With the advent of smart technologies, one can now get the details of the nutrient composition of food using applications in smartphones [3A-6A]. These applications consist of a large set of food products and ingredients and their nutrient composition. Users can type in the food products and the number of ingredients used in the cooking process. These applications calculate the nutrient composition based on the provided details. Even though these techniques are user-friendly, however, they still require users to input the correct amounts of each of the ingredients and food categories to get the exact results. This process is sometimes time-consuming. Moreover, most of the time, the dataset of food categories used is limited, which results in approximate estimation.

Therefore, there is a need for a systems and methods to estimate the temperature and/or nutrient content of food that is being heated by a microwave. Implementations of the present disclosure are directed to these and other concerns.

### SUMMARY

Systems and methods for determining the temperature and/or nutrient content of items in a microwave are described herein.

An example method for estimating the heating of an item in a microwave is described herein. The method includes receiving item information; receiving a trained water model; measuring, by an antenna, an emission value from the exterior of the microwave; determining a power flow into the item based on the trained water model, the item information, and the emission value; and estimating, by the trained water model, a temperature change of the item.

Alternatively or additionally, the trained water model includes a power amplification factor, a penetration depth correction factor, a reflection coefficient, and a dielectric coefficient.

Alternatively or additionally, determining the power flow into the item includes estimating an equivalent mass of water for the item, where the equivalent mass of water represents a mass of water that would absorb the same amount of radiation as the item.

Alternatively or additionally, determining a reflection correction value for the item.

Alternatively or additionally, determining the power flow into the item includes estimating the power absorbed by the item based on the trained water model.

Alternatively or additionally, the item information includes a mass of the item and an initial temperature of the item.

Alternatively or additionally, the trained water model includes a power amplification factor, a penetration depth correction factor, a reflection coefficient and a dielectric coefficient.

Alternatively or additionally, the method includes modifying the trained water model based on the temperature change of the item.

Alternatively or additionally, the method further includes: receiving a target temperature, and estimating, based on the temperature of the food, the power flow into the item, and the item information a time when the item will reach the target temperature.

An example method for determining the nutrient content of an item heated in the microwave is described herein. The method includes receiving item information receiving a trained water model; measuring, by an antenna, an emission value from the exterior of the microwave; determining an emission spectrum from the emission value; determining, using the emission spectrum, the item information, and the trained water model, a nutrient profile of the item.

Alternatively or additionally, the item information includes a mass of the item and an initial temperature of the item.

Alternatively or additionally, the nutrient profile includes estimates of a fat percentage, a carbohydrate percentage, and a protein percentage.

Alternatively or additionally, the method further includes estimating a dielectric constant of the item.

Alternatively or additionally, the method further includes estimating a calorie content of the item based on the nutrient profile of the item.

Alternatively or additionally, the method further includes receiving initialization parameters representing known food compositions, and where determining the nutrient profile of the item is based on the initialization parameters.

Alternatively or additionally, determining the nutrient profile of the item includes applying a plurality of estimators.

Alternatively or additionally, the estimators include water estimators, fat estimators, protein estimators, and carbohydrate estimators.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a system block diagram of system for estimating the temperature of an item in a microwave based on power leakage from the microwave, according to implementations of the present disclosure.

FIG. 2 illustrates a method of estimating the temperature of an item in a microwave based on power leakage, according to implementations of the present disclosure.

FIG. 3 illustrates a block diagram of a system for estimating the temperature of an item in a microwave based on power leakage, according to implementations of the present disclosure.

FIG. 4 illustrates a method of training a system to estimate the temperature of an item in a microwave, according to implementations of the present disclosure.

FIG. 5 illustrates a block diagram of a system for estimating the temperature of an item in a microwave, according to implementations of the present disclosure.

FIG. 6 illustrates a system for estimating the nutrient content of an item in a microwave based on power leakage form the microwave, according to implementations of the present disclosure.

FIG. 7 illustrates a method of estimating the nutrient content of an item in a microwave based on power leakage, according to implementations of the present disclosure.

FIG. 8 illustrates a block diagram of a system for estimating the nutrients of an item in a microwave, according to implementations of the present disclosure.

FIG. 9 illustrates an example of the leakage monitoring block and dielectric constant estimation block illustrated in FIG. 8, according to implementations of the present disclosure.

FIG. 10 illustrates an example system for estimating the nutrient content of an item in a microwave, according to implementations of the present disclosure.

FIG. 11 illustrates an example computing device.

FIG. 12A illustrates variation of temperature at different thickness levels (0-2 cm) for a steak heated for 1 minute. The average temperature of the food measured after heating is around 15-C. Infra-Red (IR) thermometer measured 30° C. (˜15° C. error), an example implementation (“RFTemp”) estimated the final temperature as 18° C. (˜3° C. error).

FIG. 12B illustrates a plot of power leakage over time from a microwave oven for various masses of water.

FIG. 12C illustrates power leakage from a microwave oven when different types of containers are microwaved.

FIG. 13 illustrates the attributes of an example implementation of the present disclosure.

FIG. 14 illustrates a plot of experimentally measured RF leakage around a microwave oven, where maximum leakage occurs at approximately 6 cm from the oven.

FIG. 15 illustrates experimentally measured microwave leakage for oil vs milk.

FIG. 16A illustrates power leakage observed by an experimental implementation for 1 minute by heating 100 gm of water in microwave oven.

FIG. 16B illustrates experimental and theoretical power absorbed per second for different weights of water.

FIG. 16C illustrates penetration depth correction for different weights of water.

FIG. 17A illustrates leakage patterns measured in an experimental implementation, where the area under curve maps to the RFTemp dielectric coefficient and the max leakage maps to the reflection coefficient.

FIG. 17B illustrates leakage patterns measured by an example implementation with and without water.

FIG. 18A illustrates dielectric correction and reflection correction estimation of steak and oil.

FIG. 18B illustrates the dielectric property of food with respect to water. RFTemp relative leakage values closely follow the dielectric property of the food

FIG. 18C illustrates the variation of the loss factor of water with increase in temperature from 0 to 100° C.

FIG. 18D illustrates leakage observed while heating 100 gm of water across different containers.

FIG. 18E illustrates distance biasing factors at different positions in a house both line-of-sight (LOS) and non-line-of-sight (NLOS).

FIG. 18F illustrates Leakage observed before and after microwave correction for Microwave 1 after setting the microwave bias.

FIG. 19 illustrates exemplary operations that can be performed by implementations of the present disclosure.

FIG. 20 illustrates the leakage pattern for ice for an example implementation of the present disclosure.

FIG. 21 illustrates components of an experimental implementation of the present disclosure.

FIG. 22A illustrates experimental verification of the experimental implementation of the present disclosure.

FIG. 22B illustrates performance of the experimental implementation on different containers without using corrections.

FIG. 22C illustrates the performance of the experimental implementation on different containers using corrections.

FIG. 22D illustrates experimental results showing that absolute error decreases less than 4° C. after setting distance bias.

FIG. 22E shows experimental results for an example implementation.

FIG. 22F illustrates the performance of an example implementation using different sampling rates.

FIG. 23A illustrates the performance of an experimental implementation using different foods.

FIG. 23B illustrates the performance of an experimental implementation using liquid and solid foods

FIG. 23C illustrates the performance of an experimental implementation using different containers.

FIG. 23D illustrates the performance of an experimental implementation using different food weights.

FIG. 23E illustrates the performance of an experimental implementation using frozen foods.

FIG. 24A illustrates the performance of an experimental implementation using a 15 second decision boundary.

FIG. 24B illustrates the performance of an experimental implementation using a 7.5 second decision boundary.

FIG. 24C illustrates a range of food weight and initial temperatures that can be used in an example implementation of the present disclosure.

FIG. 24D illustrates the performance of an experimental implementation using complex food.

FIG. 25A illustrates samples of rice with similar appearances, but different calorie counts due to butter added in one of the samples.

FIG. 25B illustrates samples of biriyani with similar appearances, but different calorie counts due to adding chicken to one sample.

FIG. 26 illustrates attributes of an example implementation of the present disclosure.

FIG. 27 illustrates the dielectric constants of different types of nutrients.

FIG. 28 illustrates experimentally measured spectrograms of different foods.

FIG. 29 illustrates a plot of RF leakage around an example microwave oven where maximum leakage occurs around 6 cm from the front door panel

FIG. 30 illustrates typical microwave leakage observed for 60 secs for oil and coffee.

FIG. 31 illustrates an example of a leakage monitoring block used in an example implementation of the present disclosure.

FIG. 32A illustrates an experimental result showing leakage observed while heating 200 gm of chicken, oil and water.

FIG. 32B illustrates a comparison of the theoretical dielectric constant to the dielectric constant measured by the example implementation of the present disclosure.

FIG. 33A illustrates a distribution of nutrients in an exemplary dataset.

FIG. 33B illustrates a distribution function representing water heavy foods.

FIG. 33C illustrates a distribution function for protein heavy foods.

FIG. 33D illustrates a distribution function for fat heavy foods.

FIG. 33E illustrates a distribution function for carb heavy food.

FIG. 33F illustrates the mean dielectric constant of fat heavy, carbohydrate heavy, protein heavy and water heavy foods respectively.

FIG. 34A illustrates an experimentally measured spectrum of water heavy food (100% w, 0% p, 0% c, 0% f).

FIG. 34B illustrates an experimentally measured spectrum of protein heavy food (78% w, 20% p, 0% c, 2% f).

FIG. 34C illustrates an experimentally measured spectrum of fat heavy food. (0% w, 0% p, 0% c, 100% f).

FIG. 35A illustrates a power mapping function for the maximum spectrum power value of a food.

FIG. 35B illustrates a power mapping function for the mean spectrum power value of a food.

FIG. 36 illustrates the estimators used for individual nutrients.

FIG. 37A illustrates a time frequency spectrogram for carb heavy food.

FIG. 37B illustrates a carb bias that was determined in the example implementation of the present disclosure.

FIG. 38A illustrates leakage observed while heating 150 gm of water across different containers.

FIG. 38B illustrates leakage observed before and after microwave correction for Microwave 1 after setting the microwave bias.

FIG. 38C illustrates distance biasing factors at different positions in a house both line-of-sight (LOS) and non-line-of-sight (NLOS).

FIG. 39A illustrates an experimental setup for an experimental implementation of the present disclosure.

FIG. 39B illustrates a schematic of different distances that the experimental implementation can be deployed at

FIG. 40A illustrates an experimental result showing verification of the wine water model.

FIG. 40B illustrates experimental performance of an example implementation without setting corrections.

FIG. 40C illustrates experimental performance of an example implementation after setting corrections.

FIG. 41A illustrates experimentally determined container biasing factors.

FIG. 41B illustrates experiments and containers used in experiments with the experimental implementation of the present disclosure.

FIG. 41C illustrates the classification performance of the experimental implementation across complex foods, showing a mean experimental accuracy of 81%.

FIG. 42A illustrates the performance of an example implementation across different containers.

FIG. 42B illustrates the performance of an example implementation across different receiver differences.

FIG. 42C illustrates the performance of an example implementation across different microwave ovens.

FIG. 43 illustrates comparisons of the nutrient composition of an experimentally measured dataset vs. an exemplary dataset.

FIG. 44A illustrates a comparison of the calorie content of an experimentally measured dataset vs. an exemplary dataset.

FIG. 44B illustrates nutrient estimation error of the experimental embodiment, showing a mean error of less than 5%.

FIG. 44C illustrates calorie content estimation error from the experimental embodiment, showing the mean error is 35 kcal.

FIG. 44D illustrates the performance of an experimental embodiment for high calorie foods.

FIG. 45 illustrates how estimation performed by the experimental implementation of the present disclosure correlates with the actual variation of calories due to the addition of different ingredients.

FIG. 46 illustrates an experimental result showing the accuracy of the experimental implementation of the present disclosure using different microwaves.

FIG. 47 illustrates an example implementation of the present disclosure without an initialization block.

FIG. 48A illustrates experimental results comparing an example implementation without an initialization block to an experimental implementation with an initialization block.

FIG. 48B illustrates experimental results comparing an example implementation without an initialization block to an experimental implementation with an initialization block, showing performance degradation while estimating calories.

FIG. 48C illustrates experimental results comparing an example implementation without an initialization block to an experimental implementation with an initialization block, showing performance degradation while estimating nutrients.

FIG. 49 illustrates attributes of the experimental implementation.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. As used herein, the terms “about” or “approximately” when referring to a measurable value such as an amount, a percentage, and the like, is meant to encompass variations of ±20%, ±10%, ±5%, or ±1% from the measurable value.

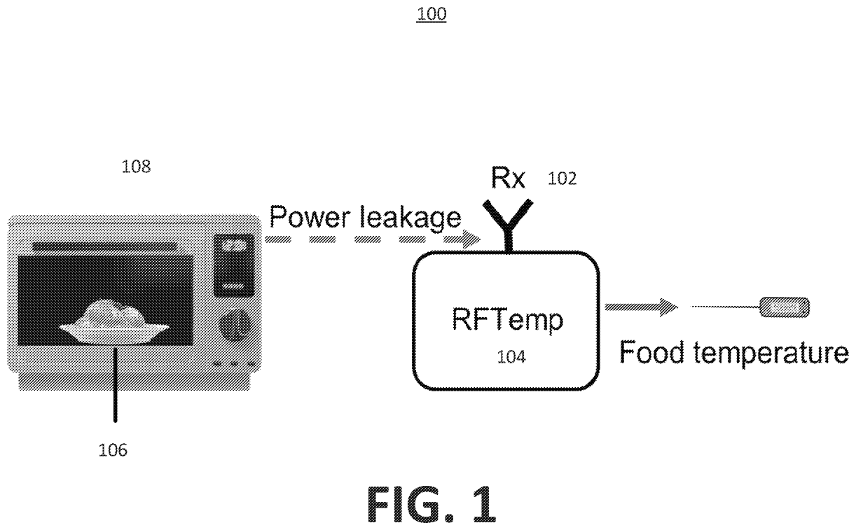

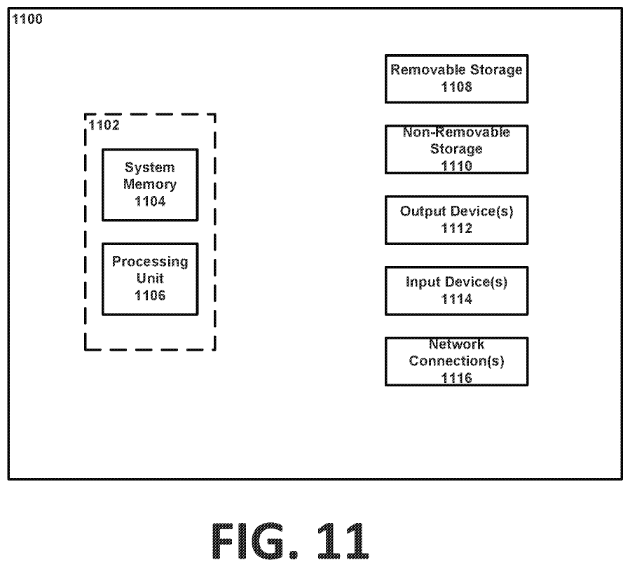

With reference to FIG. 1, implementations of the present disclosure include systems for measuring power leakage to estimate the temperature of an item in a microwave. The system 100 can include an antenna 102 and a module 104 operably connected to the antenna 102, where the module can include one or more computing devices (e.g., the computing device 1100 shown in FIG. 11) configured to receive a signal from the antenna and determine the temperature of the item 106 in the microwave 108. As shown in FIG. 1, the item 106 can be one or more food items. It should be understood that, while the present disclosure makes reference to “food” items, implementation of the present disclosure can be configured to measure the temperature of other items heated in a microwave, for example various liquids or any other objects. Additionally, it should be understood that, in some implementations of the present disclosure, the antenna 102 can include a receiver and/or analog to digital converter.

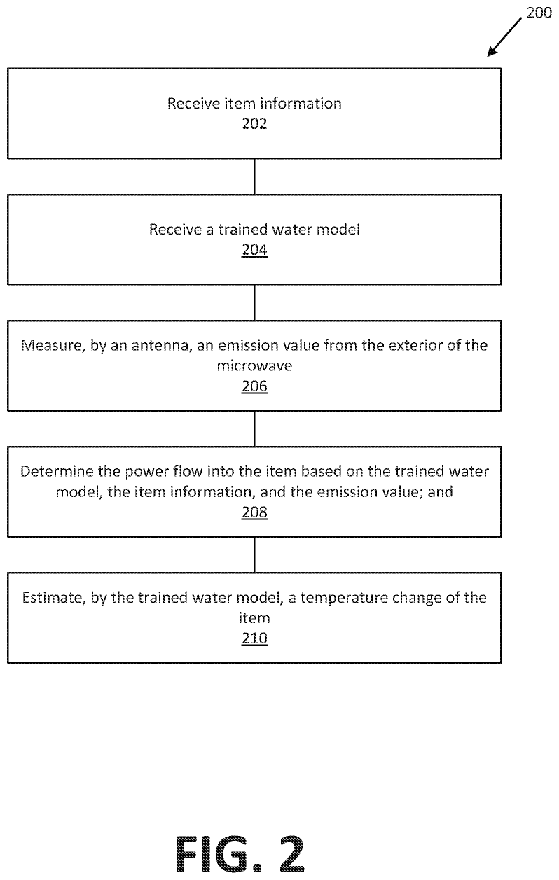

With reference to FIG. 2, the module 104 can be configured to perform methods 200 of measuring the temperature of an item in a microwave based on the radiofrequency leakage from the microwave. The method 200 can include receiving 202 item information about the item in the microwave using the module (e.g., the module 104 shown in FIG. 1). As non-limiting examples, the module can receive 202 the item information using a user interface (e.g., the input device 1114 described with reference to FIG. 11) or by a network connection (e.g., the network connection 1116 described with reference to FIG. 11). The present disclosure contemplates that the item information can also be received by retrieving it from the memory of a computing device (e.g., the memory 1104 illustrated in FIG. 11). The item information can include any property of the item, including the mass of the item and/or the initial temperature of the item.

The method 200 can also include receiving 204 a trained water model by the module (e.g., the module 104 shown in FIG. 1). For example, in some implementations, the trained water model can include a power amplification factor, a penetration depth correction factor, a reflection coefficient, and/or a dielectric coefficient. Alternatively or additionally, the trained water model can include a power amplification factor, a penetration depth correction factor, a reflection coefficient and/or a dielectric coefficient. The method can also include determining a reflection correction value for the item in the microwave. It should be understood that the trained water model can include any combination of the preceding factors and coefficients. As described with reference to step 202, the module can receive 204 the trained water module using a user interface (e.g., the input device 1114 described with reference to FIG. 11) or by a network connection (e.g., the network connection 1116 described with reference to FIG. 11). The present disclosure also contemplates that the water model can also be received by retrieving it from the memory of a computing device (e.g., the memory 1104 illustrated in FIG. 11).

In some implementations, the module can update or modify the trained water model based on the temperature of the item. For example, the trained water model can be updated based on a temperature of the item received at step 202, or the trained water model can be updated based on estimates of the temperature of the item during heating. The updated or modified trained water model can be stored in memory (e.g., the memory 1104 illustrated in FIG. 11).

The method can also include measuring 206 an emission value from the exterior of the microwave. The measurement can be performed using one or more antennas (e.g., the antenna 102 shown in FIG. 1).

The method further includes determining 208 a power flow into the item based on the trained water model and the emission value using the module. Determining the power flow into the item can include estimating an equivalent mass of water for the item, and using the trained water model to determine the power flow into the item based on the water equivalent mass. As used herein, the “water equivalent mass” or “equivalent mass of water” are used interchangeably to refer to a mass of water that would absorb the same amount of radiation as the item in the microwave.

Based on the power flow into the item, and the item information, the temperature change of the item can be estimated 210. By estimating the temperature change of the item, the temperature of the item can be determined by adding the temperature change to the initial temperature of the item. Additional details of estimating 210 the temperature change of the item are described below (e.g., with reference to Example 1).

Additionally, in some implementations, the item information can include a target temperature for the item, and the method can include estimating the amount of time it will take for the item to reach the target temperature.

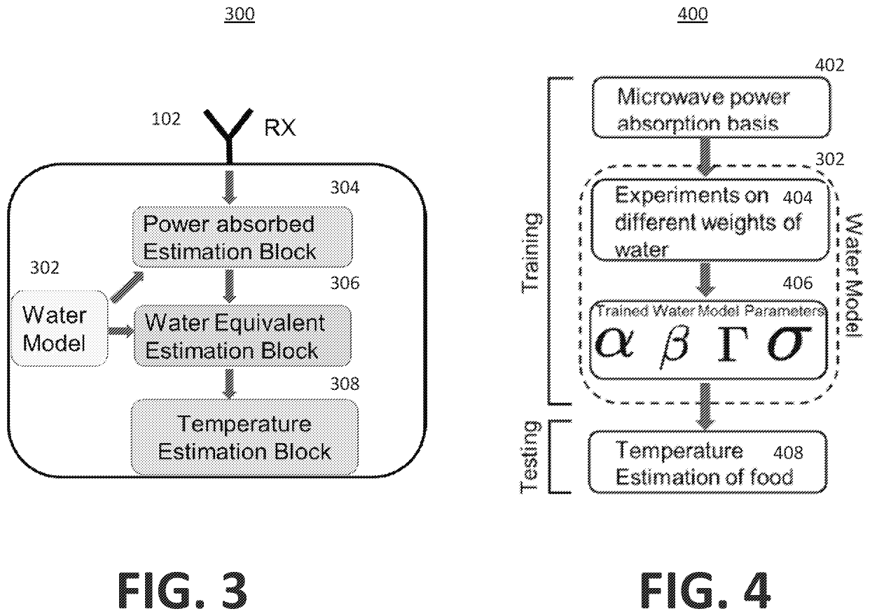

FIG. 3 illustrates a block diagram 300 of an example system for estimating the temperature of an item in a microwave using a water model 302. An antenna 102 can measure the signal leaking from a microwave oven. A power absorbed estimation block 304 can estimate the power absorbed by an item in the microwave based on the energy leaking from the microwave and the water model 302. The water equivalent estimation block 306 can estimate an equivalent mass of water that would have the same heating characteristics as the item in the microwave based on the output of the power absorbed estimation block 304 and the water model 302. The temperature estimation block 308 can estimate a temperature change of the item, or the temperature of the item, based on the output of the water equivalent estimation block.

FIG. 4 illustrates a method 400 of training a water model 302 for performing temperature estimation of food being heated in a microwave. The water model 302 can be based on an estimation of the power absorption basis 402 of the microwave, and the power absorption basis can be based on the volume of the item in the microwave and the power output of the microwave. The water model 302 can be trained by performing experimental tests 404 on different weights of water to estimate one or more trained water model parameters 406. The water model can then be tested 408 to evaluate the accuracy of the trained water model. Additional details of the method 400 are described below.

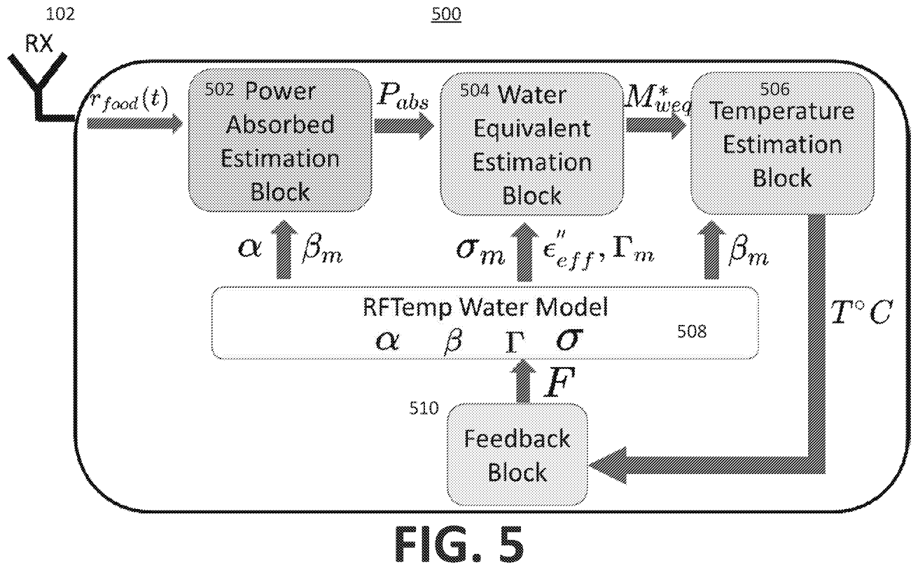

FIG. 5 illustrates a system for estimating the temperature of an item in a microwave based on a water model using feedback. The system 500 includes a power absorbed estimation block 502 operably connected to an antenna 102, a water equivalent estimation block 504, and a temperature estimation block 506 that are each configured to receive parameters from a trained water model 508 (e.g., the water model 302 trained using the method 400 illustrated in FIG. 4). A feedback block can be configured to receive temperature estimates from the temperature estimation block 506 and pass those temperature estimates to the water model 508. As non-limiting examples, the feedback block 510 can be configured to perform feedback every 15 seconds, or every 7.5 seconds, but it should be understood that any time interval for feedback can be used. The water model 508 can be configured so that one or more parameters of the water model 508 are a function of temperature, and therefore the temperature from the feedback block 510 can be used to update one or more parameters of the water model. Additional details of the system 500 are described below.

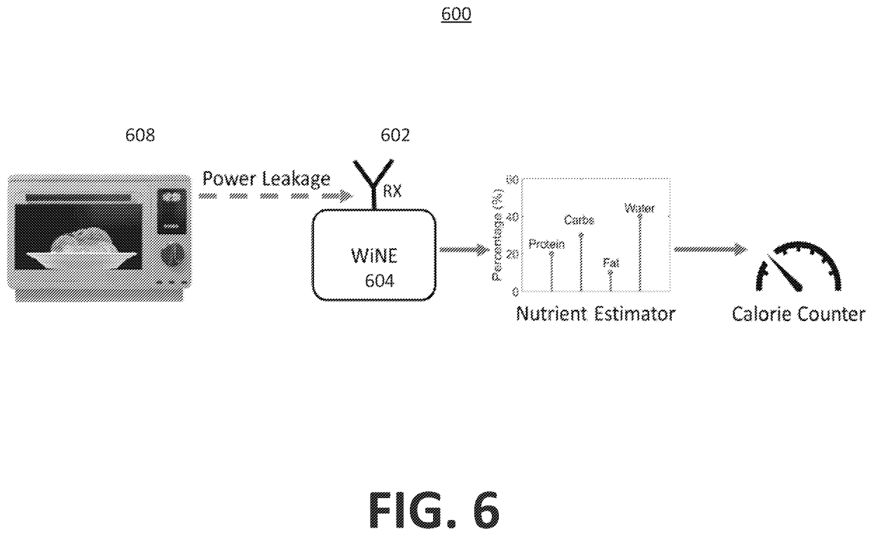

Implementations of the present disclosure can be configured to measure the nutrient content of foods. FIG. 6 illustrates a system 600 used to estimate nutrients and calories in an item being heated in a microwave. An antenna 602 placed outside the microwave can be configured to measure both the power and spectrum of energy leaking from the microwave 608. The antenna 602 can be operably connected to an estimator system 604 configured to estimate the nutrients and/or calorie content of an item being heated in the microwave 608. It should be understood that the antenna 602 can include a receiver and/or analog to digital converter to process the signal received by the antenna 602.

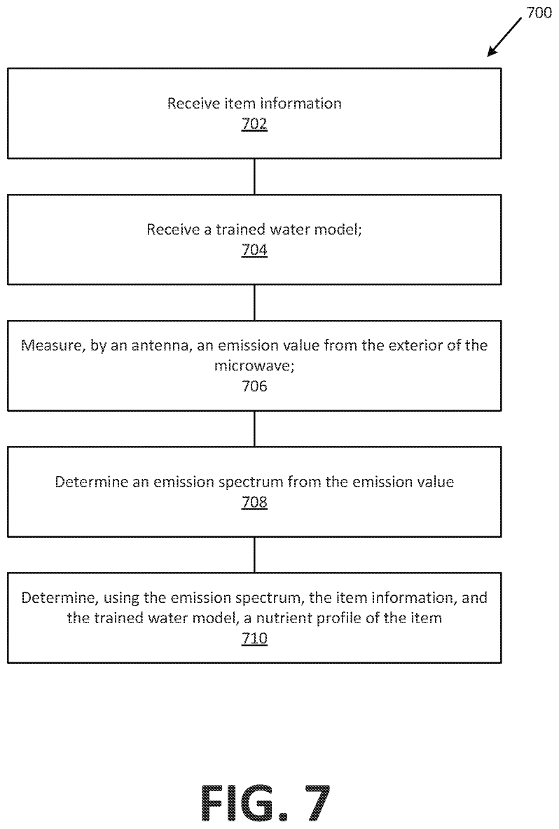

With reference to FIG. 7, the estimator system can be configured to perform methods of determining the nutrient/calorie content of items in a microwave.

The method 700 can include receiving 702 item information. The item information can include the mass of the item and/or an initial temperature of the item. As non-limiting examples, the module can receive 202 the item information using a user interface (e.g., the input device 1114 described with reference to FIG. 11) or by a network connection (e.g., the network connection 1116 described with reference to FIG. 11). The present disclosure contemplates that the item information can also be received by retrieving it from the memory of a computing device (e.g., the memory 1104 illustrated in FIG. 11).

The method 700 can further include receiving 704 a trained water model and measuring 706 an emission value from the exterior of the microwave. As described with reference to step 702, the module can receive 704 the trained water module using a user interface (e.g., the input device 1114 described with reference to FIG. 11) or by a network connection (e.g., the network connection 1116 described with reference to FIG. 11). The present disclosure also contemplates that the water model can also be received by retrieving it from the memory of a computing device (e.g., the memory 1104 illustrated in FIG. 11). The emission value can be measured 706 by the antenna (e.g., the antenna 102 illustrated in FIG. 1).

Based on the emission value measured 706, the emission spectrum can be determined 708. The emission spectrum can be determined by the antenna 102, which can include a receiver and/or analog to digital converter. Alternatively or additionally, the antenna 102 can be operably connected with a computing device (e.g., the computing device 1100 illustrated in FIG. 11, which can be part of the module 604) and the computing device can be configured to determine 708 the emission spectrum.

The method can also include determining 710, by the module 604, a nutrient profile of the item based on the emission spectrum and the trained water model. The nutrient profile can include estimates of a fat percentage, a carbohydrate percentage, and/or a protein percentage for the item. Additionally, in some implementations, the method 700 can include estimating a calorie content of the item based on the nutrient profile of the item, for example by using the mass of the item and the nutrient profile of the item to calculate the calorie content of each nutrient in the item, as well as the overall nutrient profile of the item.

In some implementations, the method can include receiving initialization parameters representing known food compositions, and determining 710 the nutrient profile of the item can include comparing the item to the known initialization parameters. For example, a computing device that is part of the module can receive the initialization parameters or have the initialization parameters stored in memory. For example, the initialization parameters can represent common compositions of food, and can be used to improve the accuracy of determining 710 the nutrient profile of the item in the microwave.

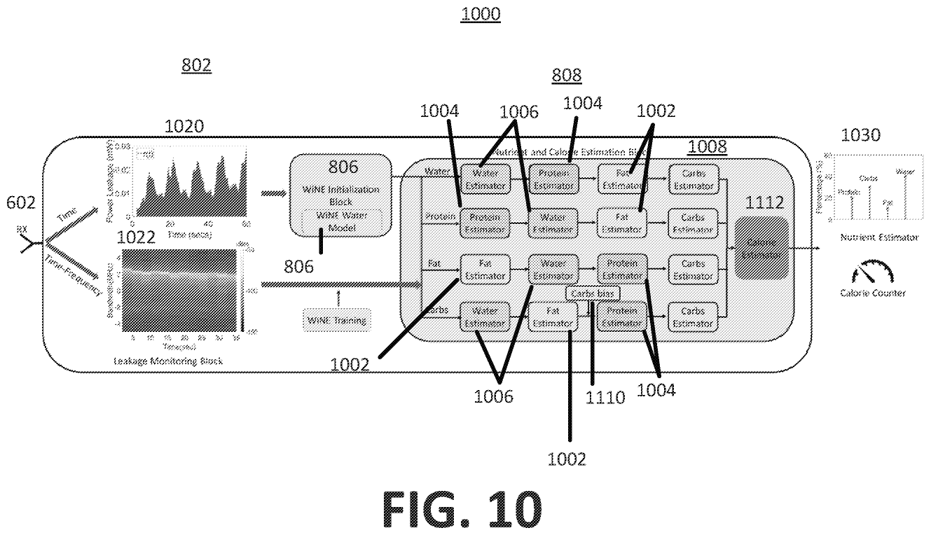

In some implementations, determining 710 the nutrient profile of the item can include applying one or more estimators. As a non-limiting example, the estimators can be one or more estimators for one or more types of nutrients (e.g., estimators configured for determining fat, carbohydrates, water and protein). Additional details of the estimators are described below, e.g., with reference to FIG. 10 and Example 2.

Additionally, the method 700 shown in FIG. 7 can include any of the steps described with reference to FIG. 2. For example, the method 700 can include using the item information and emission value to estimate a dielectric constant of the item, or to estimate the temperature and/or temperature change of the item.

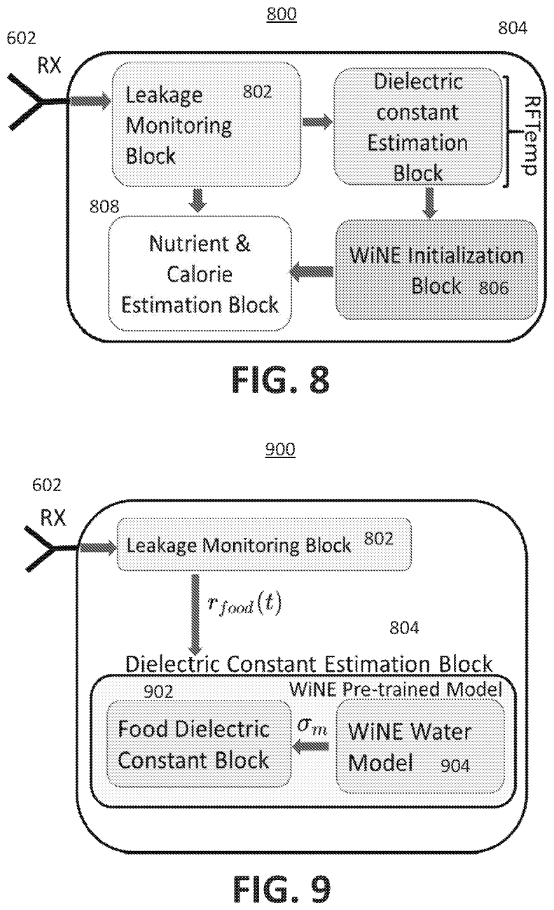

FIG. 8 illustrates a system block diagram of an implementation of the present disclosure configured to determine nutrients and calories based on leakage from a microwave oven. The system 800 includes an antenna 602 operably connected to a leakage monitoring block 802. The leakage monitoring block 802 can be operably connected to a dielectric constant estimation block 804 which can include any of the systems or methods described with reference to FIGS. 1-5 herein or described with reference to the example “RFTemp” implementation in Example 1, below. The dielectric constant estimation block 804 can be used as an input to an initialization block 806. The initialization block 806 can classify the food based on the estimated dielectric constant from the dielectric constant estimation block, and/or a database of known food nutrient compositions. The initialization block 806 can output an initialization parameter to the nutrient and calorie estimation block 808, which can estimate the nutrients and/or calories of the item in the microwave based on the initialization parameter and the leakage detected by the leakage monitoring block 802.

FIG. 9 illustrates a system block diagram 900 of a dielectric constant estimation block 804 and a leakage monitoring block 802. The leakage monitoring block 802 is operably connected to the antenna 602 and dielectric constant estimation block 804. The leakage monitoring block 802 outputs the leakage observed at the antenna 602 during a time interval to the dielectric constant estimation block 804. The dielectric constant estimation block 804 can include a food dielectric constant block 902, and a water model 904. The water model 904 can, in some implementations, be the water model described with reference to FIGS. 1-5, or described with reference to the example “RFTemp” implementation in Example 1, below.

FIG. 10 illustrates a system block diagram 1000 for an example implementation of the present disclosure. An antenna 602 generates the inputs to the system, which can be processed by the leakage monitoring block 802. The leakage monitoring block 802 is operably connected to the initialization block 806. As described above, the initialization block 806 can output an initialization parameter to the nutrient and calorie estimation block 808. In the implementation of the present disclosure shown in FIG. 10, the initialization block 806 includes a water model 1026, which can be used to determine the properties of the food. Optionally, the water model 1026 can be one of the water models described with reference to any of FIGS. 1-9, for example the water model trained in FIG. 4.

As shown in FIG. 10, the leakage monitoring block 802 can be configured to monitor the power received at the antenna 602 over time, which can correspond to the leakage from the microwave oven. The leakage monitoring block 802 can store the power received at the antenna, for example as a plot 1020 of the power leakage over time. The leakage monitoring block 802 can also monitor the spectrum of the signal received at the antenna 602. The spectrum of the signal over time can also be stored, for example as a plot 1022 representing the intensity of the signal at different frequencies, over time.

Still with reference to FIG. 10, the nutrient and calorie estimation block include estimator configured to estimate the prevalence of different nutrients. The estimators can include fat estimators 1002, protein estimators 1004, water estimators 1006, and carb estimators 1008. The system can also include biases 1110 inserted between the input of one estimator and output of another estimator. The biases 1110 can include biases for any nutrient (e.g., water, protein, fat, and/or carbs). The output of the estimators 1002 1004 1006 1008 is input into a calorie estimator 1112. The calorie estimator 1112 can estimate the total number of calories in an item based on the mass of the item and the relative nutrient percentages in the item determined by the estimators. Optionally, the outputs of the system 1030 1032 can include plots showing the nutrient density or relative nutrient percentages in the item in the microwave. For example, a plot of the nutrients 1030 in a non-limiting example item is illustrated in FIG. 10.

It should be appreciated that the logical operations described herein with respect to the various figures may be implemented (1) as a sequence of computer implemented acts or program modules (i.e., software) running on a computing device (e.g., the computing device described in FIG. 11), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 11, an example computing device 1100 upon which the methods described herein may be implemented is illustrated. It should be understood that the example computing device 1100 is only one example of a suitable computing environment upon which the methods described herein may be implemented. Optionally, the computing device 1100 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1100 typically includes at least one processing unit 1106 and system memory 1104. Depending on the exact configuration and type of computing device, system memory 1104 may be volatile (such as random access memory (RAM)), non-volatile (such as read-only memory (ROM), flash memory, etc.), or some combination of the two. This most basic configuration is illustrated in FIG. 11 by dashed line 1102. The processing unit 1106 may be a standard programmable processor that performs arithmetic and logic operations necessary for operation of the computing device 1100. The computing device 1100 may also include a bus or other communication mechanism for communicating information among various components of the computing device 1100.

Computing device 1100 may have additional features/functionality. For example, computing device 1100 may include additional storage such as removable storage 1108 and non-removable storage 1110 including, but not limited to, magnetic or optical disks or tapes. Computing device 1100 may also contain network connection(s) 1116 that allow the device to communicate with other devices. Computing device 1100 may also have input device(s) 1114 such as a keyboard, mouse, touch screen, etc. Output device(s) 1112 such as a display, speakers, printer, etc. may also be included. The additional devices may be connected to the bus in order to facilitate communication of data among the components of the computing device 1100. All these devices are well known in the art and need not be discussed at length here.

The processing unit 1106 may be configured to execute program code encoded in tangible, computer-readable media. Tangible, computer-readable media refers to any media that is capable of providing data that causes the computing device 1100 (i.e., a machine) to operate in a particular fashion. Various computer-readable media may be utilized to provide instructions to the processing unit 1106 for execution. Example tangible, computer-readable media may include, but is not limited to, volatile media, non-volatile media, removable media and non-removable media implemented in any method or technology for storage of information such as computer readable instructions, data structures, program modules or other data. System memory 1104, removable storage 1108, and non-removable storage 1110 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1106 may execute program code stored in the system memory 1104. For example, the bus may carry data to the system memory 1104, from which the processing unit 1106 receives and executes instructions. The data received by the system memory 1104 may optionally be stored on the removable storage 1108 or the non-removable storage 1110 before or after execution by the processing unit 1106.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

An experimental embodiment of the present disclosure referred to as “RFTemp” was constructed and tested. RFTemp includes a system that can monitor microwave oven leakage to estimate the temperature of the food that is being heated and thus estimate the accurate time when the food has reached the targeted temperature. RFTemp can include a microwave leakage sensing procedure and a water-equivalent food model to estimate food temperature. To evaluate the real-world performance of RFTemp a prototype was constructed using software defined radios and conducted experiments on various food items using household microwave ovens. The study shows that RFTemp can estimate the temperature of the food with a mean error of 5° C., 2× improvement over contactless infrared thermometer and sensors.

An implementation of RFTemp is illustrated in FIG. 1, including an RF sensing system that can monitor leakage coming out from the microwave oven window to estimate the temperature of the food that is getting heated. The RFTemp system can include several advantages: an intelligent RF sensing technique that can retrieve information from the microwave leakage and directly map it to the amount of heat absorbed by the food. Additionally, the RFTemp system can include a water-equivalent food model that maps the food properties to an equivalent, known water model to determine the temperature and the properties of the heated food. RFTemp can also include error correction techniques that make RFTemp robust to any microwave containers and distance of measurements.

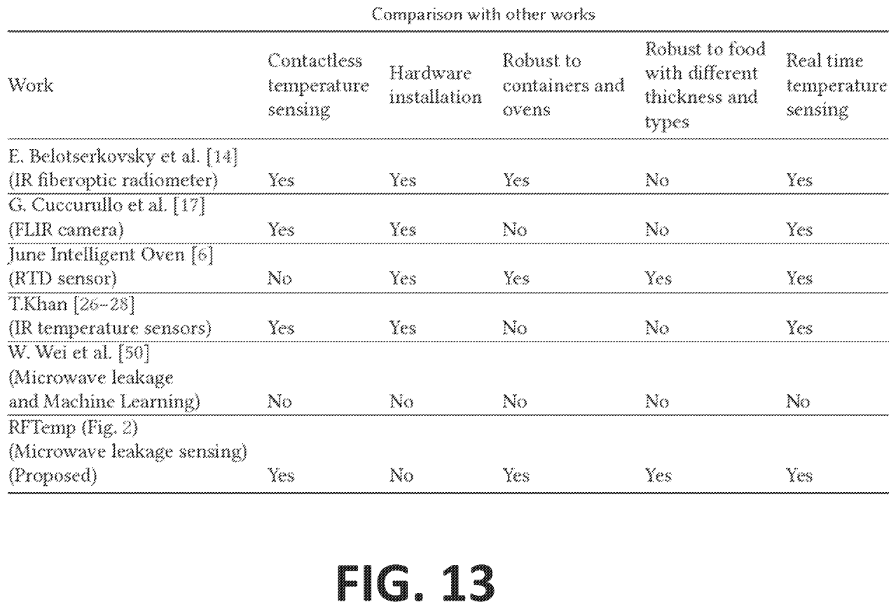

FIG. 13 shows the comparison between RFTemp and other methods.

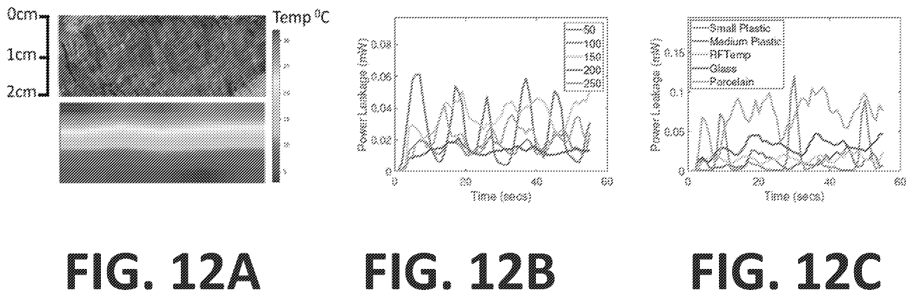

Camera-based techniques [5,6,15,17,31], installation of Infra-Red (IR) temperature sensors [14,30,33,44], image classification and temperature sensing technique [26,31], monitoring leakage to classify food types [50] have been employed. However, these techniques can require direct contact with the food or require installation of sensors and cameras on the microwave oven which is not cost-efficient and cannot be installed by users easily. Over that, temperature sensors and thermal cameras can only measure the temperature of the surface of the food [41]. FIG. 12A shows the thermal map after heating a steak for 1 minute. With increasing thickness, the temperature decreases from the surface. Thus, for thick food like meat, the infrared sensors and cameras can result in errors in temperature estimation of the food as the surface heats faster than inside. Even the machine learning and image processing-based approach can only successfully classify a given set of food of a particular weight and using a specific container. FIG. 12B shows the leakage observed for different weights of water using a particular microwave container. FIG. 12C shows the leakage observed for 100 gm of water across different containers. The leakages can be different across weights and containers. This can affect the accuracy of the leakage classification techniques [50] if not taken under consideration and training models for all such weights, containers, and food combinations is not realistic.

Typical household microwave ovens operate at a frequency of 2.45 GHz with a bandwidth of only a few MHz [47]. They use a high-powered vacuum tube called magnetron [10] that converts the electrical input of the oven into a microwave signal that oscillates at 2.45 GHz. A wave-guide directs these signals from the magnetron into the metal cooking chamber of the microwave oven where it creates an alternating electromagnetic field [47]. In a microwave oven, the electrically bipolar molecules present in the food (like water) absorb most of these microwaves by a process called dielectric heating [11] and causes molecular vibration, which eventually results in heating the food. The important components of microwave heating are as follows:

### Power Absorbed by Dielectric Material

The average power absorbed (P_{abs}Watts/m³) by a dielectric of volume V is given by Eq. 1 [18], where ω is the angular frequency of microwave, ϵ₀=8.8542*10⁻¹² F/m is the permittivity of free space, ϵ″_{eff} is the effective loss factor of the dielectric and E is the microwave electric field.

$${P}_{abs} = {ωϵ}_{0} {ϵ}_{eff}^{″} {E}^{2} V \qquad ( 1 )$$

To be noted that P_{abs} is the prime source of microwave heating that dissipates in the food.

Permittivity: The interaction of the dielectric with the electric field is characterized by its permittivity (ϵ). The permittivity of a dielectric is expressed by Eq. 2 [18], where ϵ₀ is the permittivity of free space and ϵᵣ is the relative permittivity of the material. The ϵᵣ is a complex term and can be expressed by a real part (ϵ′) also known as dielectric constant and an imaginary part (ϵ″_{eff}) as shown in Eq. 3.

$$ϵ = {ϵ}_{0} {ϵ}_{r} \qquad ( 2 )$$

$${ϵ}_{r} = {ϵ}^{′} - j {ϵ}_{eff}^{″} \qquad ( 3 )$$

ϵ″_{eff} measures the losses when electromagnetic radiations are absorbed by the dielectric and ϵ′ determines lossless storage and how much radiation is reflected at the surface of the dielectric. Permittivity is an important measure of the property of the food. However, permittivity is temperature dependent and in most of the foods it decreases with increase in temperature [18].

Penetration Depth: Power penetration depth or simply the penetration depth δₚ of dielectric material is the measure of how far the electromagnetic fields can penetrate the material before it gets attenuated to one-third of its value on the surface [18]. Thus, food with a thickness smaller than δₚ absorbs the radiation uniformly compared to a thick food. The penetration depth can be expressed by Eq. 4[3,18], where λ is the wavelength of microwave signal and ϵ′>>ϵ″_{eff} which is valid for most of the food materials. With increase in temperature δₚ decreases as ϵ′ decreases.

$${δ}_{p} = ( λ / 2 π ) ( \sqrt{{ϵ}^{′}} / {ϵ}_{eff}^{″} ) \qquad ( 4 )$$

Reflection Coefficient: When the microwaves hit the dielectric material, a part of it gets reflected, and a part penetrates the material. Permittivity is directly proportional to the square of the refractive index [47]. Thus using Eq. 4, penetration depth is inversely proportional to the square the complex part of the refractive index of the medium [47]. On the other hand, theoretical power-reflectance or the reflection coefficient is directly proportional to the refractive index of the material [18]. Thus, δₚ is indirectly related to reflection coefficient. Shallower the penetration depth, more is the reflection. Thus, with an increase in temperature, as penetration depth decreases, the reflection coefficient increases.

All these parameters play an important role in determining the temperature of the food getting heated in the microwave oven. However, to measure these properties explicitly, specialized instruments and direct access to the microwave oven food chamber can be required, which can be difficult because microwave radiation can be highly dangerous to human health and can cause damage to other electrical instruments [18]. Moreover, the food chamber acts as a Faraday cage that attenuates most of the electromagnetic radiation escaping from the oven [4]. United States Federal standard limits the amount of microwaves that can leak from an oven throughout its lifetime to 5 milliwatts (mW) of microwave radiation per square centimeter at approximately 2 inches from the oven surface. Thus a very small portion of the RF waves is able to penetrate through the microwave oven walls which makes the RF sensing highly difficult.

RFTemp addresses this challenge by proposing an intelligent sensing technique to retrieve useful information from the microwave leakage. Details of the process are described in Section 5.

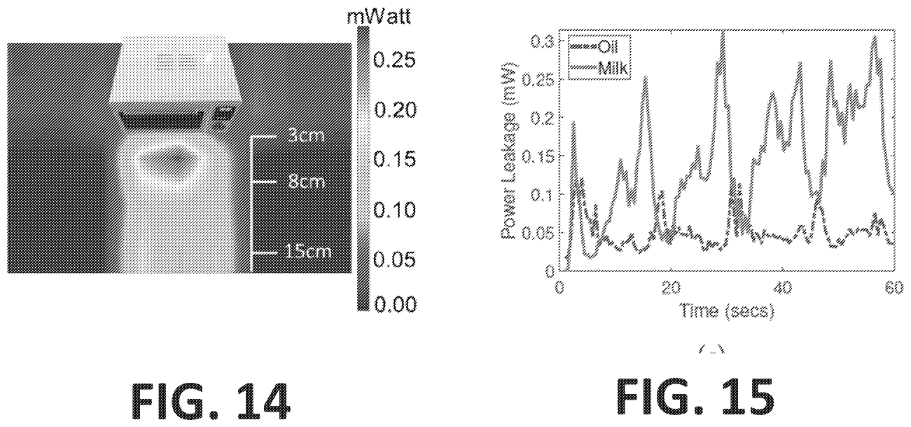

FIG. 14 shows a heat map of the microwave leakage power around the microwave oven. The maximum leakage occurs through the front-door panel of the microwave oven and, it gets attenuated with increasing distance. Even though microwave oven (operating at 2.45 GHz) shares the same RF spectrum as other household applications like WiFi, Bluetooth, however, the power density of these applications are several times smaller than the measured microwave leakage and thus causes no interference. RFTemp leverages this leakage in real-time to estimate the temperature of the food in the microwave oven. FIG. 3 shows the overall system design of RFTemp. FIG. 15 shows a typical leakage pattern observed by RFTemp while heating 100 gm of milk and oil respectively in the microwave oven for a duration of 1 minute. The power leakage value varies in intervals of ˜15 secs which is equivalent to one cycle duration of the turntable plate in the microwave oven [50]. Moreover, the leakage is different for oil and milk. The time varied power leakage pattern can be used to evaluate the food property and estimate the temperature of the food in the microwave oven.

FIG. 4 shows the different stages of RFTemp design model. The first stage uses fundamental concepts of electromagnetic radiation to develop a simplified measurable power absorption variable. To estimate the power absorption and to find a relation with the microwave oven leakage, RFTemp introduces a novel water model. Based on the microwave absorption basis and experiments on water with different weights, the water model defines four different experimental parameters. Using these trained parameters, the example implementation of the system maps the leakage observed to the power absorbed by the food inside the microwave oven and develops experimental properties of water. These together make the training phase of the design model. The last part of design model uses these trained water model parameters and the real time microwave oven leakage to estimate the temperature of the food. Each of these blocks are discussed in detail in this section.

Microwave Power Absorption Basis: As shown in Eq. 1, the power absorbed by any food in a microwave oven depends on the electric field strength E inside the oven. It is difficult to directly estimate this electric field strength may or may not be access to the food chamber. RFTemp utilizes the fundamental concepts of electromagnetic radiation to solve this challenge. Implementations of the disclosure include a simple model assuming the electromagnetic radiation in microwave oven as plane waves in free space.

The energy associated with the electromagnetic wave is the sum of the energies of the electric and magnetic fields as shown in Eq. 5, where u is the energy per unit volume or total energy density and uₑ and u_{b} are the energy density of electric field and magnetic field respectively.

$$u = {u}_{e} + {u}_{b} \qquad ( 5 )$$

Eq. 5 can be rewritten based on [32,36] as

$$u = \frac{1}{2} {ϵ}_{0} {E}^{2} + \frac{1}{2 {μ}_{0}} {B}^{2} \qquad ( 6 )$$

$$Since E = cB = \frac{1}{\sqrt{{ϵ}_{0} {μ}_{0}}} B ,$$

where c is the speed of light,

$$u = {ϵ}_{0} {E}^{2} \qquad ( 7 )$$

where E and B are the electric and magnetic field strengths respectively, ϵ₀ is the permittivity of free space and μ₀ is the permeability of free space. Thus, the energy flux (S) associated with the wave can be represented as

$$S = uc = {ϵ}_{0} {cE}^{2} \qquad ( 8 )$$

The power per unit area (A) is the time average of this energy flux (S). Thus from Eq. 8,

$$\frac{P}{A} = \frac{1}{2} {ϵ}_{0} {cE}^{2} \qquad ( 9 )$$

Thus, for a microwave oven with an average surface area of A_{avg} and output power of P_{micro} (1000 Watt), Eq. 9 can be rewritten as

$${P}_{micro} = \frac{1}{2} {ϵ}_{0} {cE}^{2} {A}_{avg} \qquad ( 10 )$$

Based on the above derivation Eq. 1 can be rewritten as

$${P}_{abs} = \frac{4 π}{λ} {ϵ}_{eff}^{″} \frac{{V}_{food}}{{A}_{avg}} {P}_{micro} \qquad ( 11 )$$

where,

$$ω = \frac{2 π c}{λ} ,$$

Δ is the wavelength of electromagnetic radiation. P_{abs} now depends on measurable variables and can be estimated. However, V_{food} here is the volume of the food exposed to microwave radiation uniformly, that is, the thickness of the food is less than the penetration depth of the microwave signals.

Water Model: Even though Eq. 11 helps us to estimate the power absorbed by the food inside a microwave oven, it is difficult to explicitly measure both V_{food} and ϵ″_{eff}. This is because different types of food have different penetration depths due to their complex permittivity. Similarly, the e term is dependent on the constituents of food like protein, fat, carbohydrate, and water. Thus, estimating these factors for everyday food is not trivial. Moreover, it is not clear how the leakage observed through the microwave door is related to the power absorbed by the food. Implementations of the present disclosure include a water model to estimate the P_{abs} directly from the microwave leakage observed over time.

The study conducted series of experiments with the weight of water ranging from 50-500 gm (at room temperature). The receiver antenna (Rx) of the RFTemp can be placed at a 6 cm distance from the center of the microwave oven front door to measure the power leakage pattern r(t) for each load of water microwaved for 15 secs duration. The study physically measured the initial and final temperature of the water with a food thermometer. Most of the recent microwave oven has a turntable cycle of 15 secs. So the training interval for RFTemp was chosen to be 15 secs. However, this can be further reduced to a time less than 15 secs. Based on these experiments, the example implementation included the following terms.

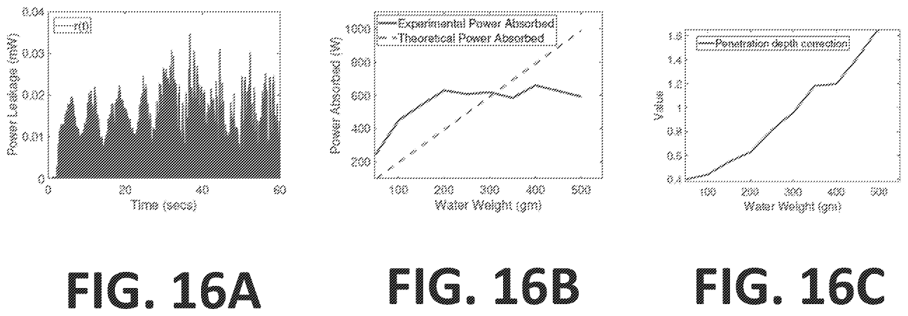

Power Amplification Factor (a). From Eq. 11, P_{abs}<=P_{micro} Most of this radiation that is not absorbed by the food (E_{leakage}) escapes through the front panel of the microwave oven after getting attenuated.

$${E}_{leakage} = ( {P}_{micro} - {P}_{abs} ) \times τ = {E}_{micro} - {E}_{abs} \qquad ( 12 )$$

where r is the time duration in seconds and E_{leakage} is the total leakage energy observed, and E_{abs} is the total energy absorbed for r secs. FIG. 16A shows a typical power leakage pattern, r(t), observed for τ=60 secs. Thus,

$${E}_{leakage} = α {\sum }_{t = 0}^{τ} r ( t ) \qquad ( 13 )$$

The power amplification factor (α) maps this leakage observed outside, r(t), to the original power leakage inside the microwave oven. However, to estimate α E_{abs} can be calculated based on Eq. 12 and 13.

Thus using the experimentally measured initial and final temperatures of different weights of water and the heat capacity relationship (Eq. 14) the study calculated the heat energy absorbed by the equivalent mass of water for 15 secs duration.

$${E}_{heat} ( m , T ) = {P}_{heat} ( m , T ) \times τ = ms ( t 2 - t 1 ) \qquad ( 14 )$$

where m and s are the mass and specific heat of water, t2 and t1 are the final and initial temperatures and r=15 secs. Eₕₑₐₜ is dependent on mass and temperature difference of the water. The solid line in FIG. 16B shows the power absorbed per sec by corresponding mass of water. Now Eₕₑₐₜ is nothing but E_{abs} for the whole volume of water. Thus a can be expressed as

$$α = \frac{( {P}_{micro} - {P}_{heat} ( m , T ) ) \times τ}{{\sum }_{t = 0}^{τ} r ( t )} = \frac{{E}_{micro} - {E}_{heat} ( m , T )}{{\sum }_{t = 0}^{τ} r ( t )} \qquad ( 15 )$$

In the above-mentioned experimental setup, for τ=15 secs, α˜150 for all the experiments. Thus, it is to be noted, the power amplification factor depends on experimental variables only like the distance between the receiver and microwave oven front panel, microwave oven output power, and the microwave container shape. It is independent of the properties of food. To address these experimental factors, the example implementation includes error correction techniques described below.

Penetration Depth Correction (β(m, T)). The dotted line in FIG. 16B (time averaged values are shown) shows the theoretical power absorbed P_{abs} for the same mass of water used for the power amplification factor calculations. P_{abs} is calculated using Eq 11, where ϵ″_{eff}˜10 for water (at room temperature). From FIG. 16B, Pₕₑₐₜ experimental is highly uncorrelated with P_{abs} theoretical. The main reason behind this is, as the weight of water increases, the microwave radiation is not uniformly absorbed. To compensate for this error, the study defined the penetration depth correction factor β as the ratio between E_{abs} and Eₕₑₐₜ, so that both the theoretical and experimental energy absorbed values map to the same mass of the food.

$$β ( m , T ) = \frac{{E}_{abs} ( m , T )}{{E}_{heat} ( m , T )} = \frac{{P}_{abs} ( m , T ) \times τ}{{P}_{heat} ( m , T ) \times τ} = \frac{{P}_{abs} ( m , T )}{{P}_{heat} ( m , T )} \qquad ( 16 )$$

FIG. 16C shows the P(m, T) variation with different weights of water. It is to be noted that, this factor depends on the mass (m) and temperature (T) of the food. With increase in temperature P_{abs} decreases as ϵ″_{eff} decreases, thus β² decreases. However, during the training phase for 15 secs, β is independent of the temperature factor It is only effective while measuring microwave leakage at the end of every 15 secs time slot as explained in the feedback block in Sec 5.3. β is calculated as the ratio between a theoretical quantity and an experimentally measured quantity. Both of them are independent of the experimental environment so β is also independent of experimental environment.

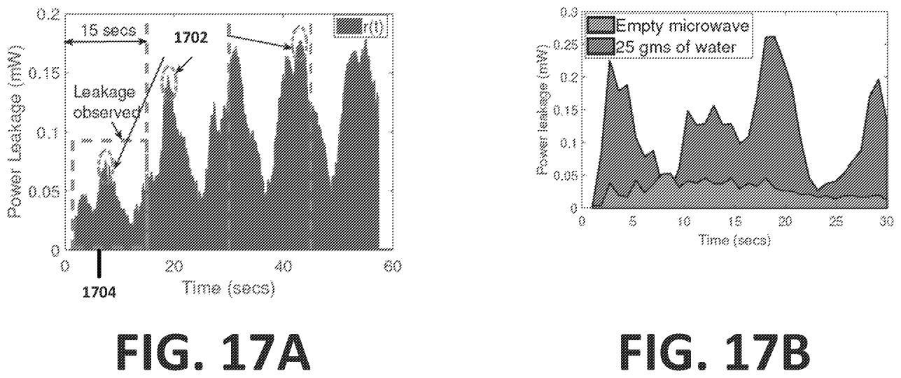

Reflection Coefficient (Γ(m, T)). This experimental coefficient has an indirect relationship with the penetration depth of the food. Shallower penetration depth results in more reflection of the incident radiation. To address this factor, Γ² is introduced, which is measured as the maximum leakage during one cycle of rotation of the microwave oven turntable (˜15 secs). FIG. 17A shows a typical leakage pattern observed. It is a realistic estimation, as the leakage observed is directly proportional to the reflection of the incident wave on the food. To verify this claim, the study included experiments on 25 gm of water and an empty microwave.

As shown in FIG. 17B, when there is no food in the oven there is a nominal leakage. However, in such a situation the leakage will slowly decrease with time. However, even there is a very small load like 25 gm of water, the leakage is quite dominant, and a cyclic pattern can be observed which is mainly because of the food present inside. Thus, the leakage observed is related to the reflection of the microwave from the food items to certain extent. This reflection coefficient corrects for overestimation of the water equivalent of any food.

$$Γ ( m , T ) = m ( r ( n ) : n = [ 0 … 15 ] ) \qquad ( 17 )$$

where n is measured in seconds and r is the leakage observed. As shown in FIG. 17A, Γ is marked by the dotted circles 1702 which represent the maximum leakage observed in 15 secs interval (the reflection observed). Γ is dependent on the mass and temperature of the food as the leakage pattern is different for different weights of water and with increase in temperature, reflection coefficient increases as mentioned in previous section. Similar to the penetration depth correction parameter, Γ varies with temperature after every 15 secs time slot.

β(m, T), Γ(m, T) and σ(m) are represented in many places as β, Γ and a respectively for simplicity.

RFTemp Dielectric Coefficient (σ(m)). This parameter is used to measure the experimental dielectric property of water. It is expressed as the area under the power leakage curve r(t). It is an experimental measure of the food property and how good they can absorb the radiation. The study calculated σ² for different water experiments as the leakage pattern is different. These values were used as an example training set. Thus it is dependent on the mass of water. The study also verified the accuracy of this parameter, as described herein.

$$σ ( m ) = {\sum }_{t = 0}^{τ} r ( t ) \qquad ( 18 )$$

In FIG. 17A, the area under curve marked by the dotted box 1704 shows the leakage observed will heating 400 gm of water for 15 secs. It is to be noted that a can be an experimental parameter focused for a system.

The parameters β, Γ and σ are measured for weights of water within a range of 50 to 500 gm.

This phase of defining the water model is called the RFTemp training phase. Using this trained water model as reference, the system estimates the temperature of the food every 15 secs that is being heated.

### Temperature Estimation of Microwaved Food

Based on the proposed water model, RFTemp introduces the following design blocks to estimate the food temperature every 15 secs interval. FIG. 5 shows the workflow of RFTemp.

Power Absorbed Estimation Block. RFTemp observes the power leakage when the food is being heated and calculates Σₜ₌₀^{τ}r_{food}(t), where τ is equal to 15 secs duration. Now, with the known α, and corresponding β, calculated using the water model, the power absorbed by the food inside the microwave oven can be estimated by Eq. 19 and 20

$$α {\sum }_{t = 0}^{τ} {r}_{food} ( t ) = {E}_{leakage} \qquad ( 19 )$$

$${E}_{abs} = {β}_{m} \times {E}_{heat} = {β}_{m} \times ( {E}_{micro} - {E}_{leakage} ) \qquad ( 20 )$$

where, βₘ is the penetration depth correction factor for the particular mass of food (m) and Σₜ₌₀^{τ}r_{food}(t) is the area under the leakage curve. It is to be noted that βₘ is taken from the water model parameter β(m,T) which consists of series of values for different weights of water. For example, β₁₀₀ represents the penetration depth correction factor value β for 100 gm of water.

Water Equivalent Estimation Block. From the calculated E_{abs} the equivalent mass of water (M_{weq}) can be estimated using Eq. 11. M_{weq} is the equivalent mass of water when replaced with the food, will absorb the same amount of radiation. The density of water is taken as 1 gm/cc.

$$\frac{{E}_{abs} {A}_{avg}}{{E}_{micro}} \times \frac{λ}{4 π {ϵ}_{eff}^{*}} = {M}_{weq} \qquad ( 21 )$$

Dielectric Correction: However, to address the dielectric property of different food (i.e., how easily it can absorb the microwaves), the relative dielectric property of the food with respect to water (ϵ*_{eff}) can be used.

$${ϵ}_{eff}^{*} = \frac{{ϵ}_{eff}^{″}}{\sqrt{(} \frac{{\sum }_{t = 0}^{τ} {r}_{food} ( t )}{{σ}_{m}} )} \qquad ( 22 )$$

where, Σₜ₌₀^{τ}r_{food}(t) is the leakage observed by RFTemp while heating the food in the microwave oven, and σₘ is the RFTemp dielectric coefficient of water of same weight as that of the food taken from the water model parameter σ(m), introduced in the previous section.

Reflection Correction: Some food may have shallower penetration depth, compared to water, and results in larger reflection of microwaves. Larger reflection or leakage means smaller absorption, resulting in underestimation of water equivalent mass. To address this factor, a reflection correction parameter (Γ*) can be used.

$${Γ}^{*} = \frac{{Γ}_{food}}{{Γ}_{m}} \qquad ( 23 )$$

where Γ_{food}=max(r_{food}(n): n=[0 . . . 15]), n is measured in seconds and Γₘ is the reflection coefficient of the corresponding mass of water taken from the water model parameter Γ(m,T). Thus, the final water equivalent mass for the food is

$${M}_{weq}^{*} = {M}_{weq} \times {Γ}^{*} \qquad ( 24 )$$

However, it is to be noted that, this reflection correction occurs only when Γ*>1. ϵ*_{eff} and Γ* are used to estimate the food property and are different from the parameters of water model (ϵ″_{eff} and Γ).

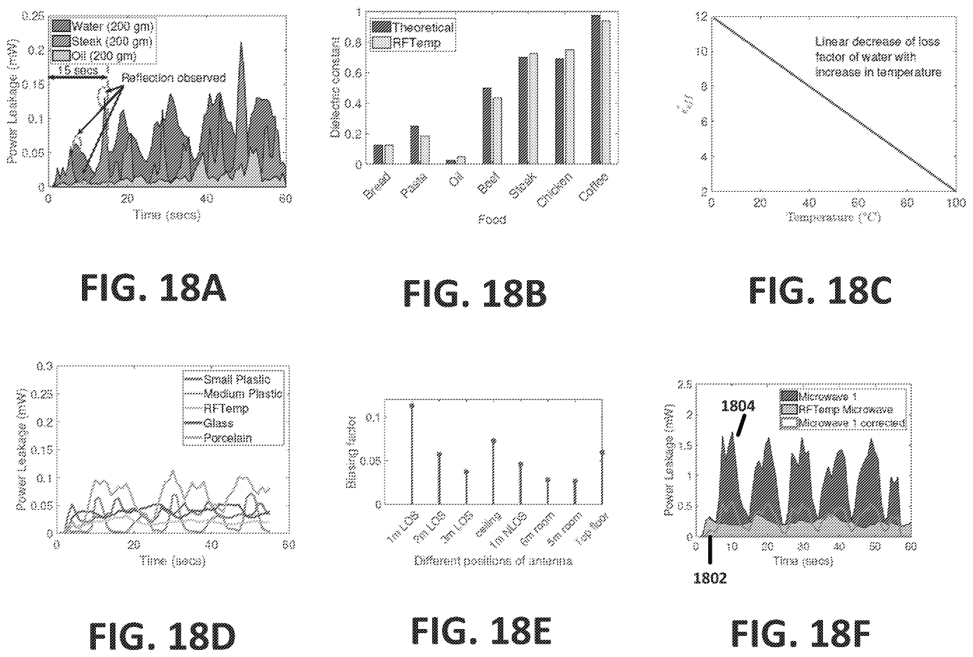

Realization of Dielectric and Reflection Correction: FIG. 18A shows the leakage observed by water, steak, and oil, each of 200 gm when heated for 1 minute duration. In the first 15 secs time slot, the area under the curve of both steak and oil is less than water. Qualitatively it shows that these foods have a lesser affinity to absorb electromagnetic radiation than water. Thus, even though smaller leakage points to higher absorption, these absorbed radiations due to lack of polar molecules in the food cannot result in dielectric heating. FIG. 18A shows that the leakage observed by steak is around 0.7 times of water while that of oil is 0.03 times of water. Dielectric correction takes care of this property of food and accurately estimates the M_{weq}. Similarly, the reflection observed by the foods is shown in FIG. 18A by the dotted circles. Steak has high reflection compared to water, which means the penetration depth is shallower. This factor is taken care of by the reflection correction parameter (Γ*).

Dielectric value of steak measured in [35] by a cavity perturbation technique is around 58, while that of oil is around 2. Compared to the dielectric value of water (80), the dielectric property of steak relative to water is ˜0.725 while that of oil is ˜0.025. These values closely match with the relative leakage observed values by the system (steak—0.7 and oil—0.03). FIG. 18B shows the relative dielectric property of different foods with respect to water. The RFTemp relative leakage parameter closely follows the theoretical values. This verifies that the area under the leakage curve accurately estimates the dielectric property of the food. The dielectric correction parameter (ϵ*_{eff}) introduced, thus takes care of the property of the food.

Temperature Estimation Block. Once the water equivalent mass is known, the specific heat relationship can be used to find the final temperature of the food in the microwave oven.

$${t}_{final} = \frac{{E}_{abs}}{{M}_{weq}^{*} \times S \times {β}_{weq}} + {t}_{initial} \qquad ( 25 )$$

Here S is the specific heat capacity of water since the M*_{weq} is the weight of water equivalent of the food. β_{weq} is the penetration depth correction for the water equivalent of weight M*_{weq}. E_{abs} calculated can be converted to Eₕₑₐₜ before using the heat capacity equation. For that reason a new β_{weq} can be used for this new M*_{weq} which converts E_{abs} to Eₕₑₐₜ before using the heat capacity equation (Eq. 25).

5.3.4 Feedback Block. This process can be repeated every 15 secs. However, ϵ″_{eff} of water is temperature dependent, the parameters ϵ*_{eff}, βₘ and Γ* also varies with temperature due to the temperature dependency of the trained water model parameters. FIG. 18C shows the behavior of ϵ″_{eff} with temperature theoretically [25] To address this variation the t_{final} is a feedback into the next 15 secs slot to estimate the new ϵ″_{eff}. The feedback parameter F is the ratio of new dielectric loss ϵ″_{eff}^{Tc} at temperature T to the ϵ″_{eff}

$$F = \frac{{ϵ}_{eff}^{″}}{{ϵ}_{eff}^{″}} \qquad ( 26 )$$

$${β}_{m}^{T} = F \times {β}_{m} \qquad ( 27 )$$

$${ϵ}_{eff}^{* T} = F \times {ϵ}_{eff}^{*} \qquad ( 28 )$$

$${Γ}^{* T} = F \times {Γ}^{*} \qquad ( 29 )$$

where βₘ^{T}, ϵ*_{eff}^{T} and Γ*^{T} are the updated values at temperature T after using feedback F.

RFTemp uses these blocks to accurately estimate the temperature of the food. The leakage observed is directly related to how the food interacts with the microwave radiation. It is to be noted that since RFTemp uses the observed leakage to determine the properties of food, the estimation of temperature is the average of the whole food rather than just the surface.

Both the dielectric correction and the reflection correction parameters depend on the leakage observed over time, r_{food}(t). The example implementation can measure the leakage and define intelligent biasing techniques to overcome errors.

Container Effect. To understand the effect of containers of different shapes on the leakage observed, the study microwaved 100 gm of water across different containers for 1 minute. FIG. 11 shows that leakage pattern across different containers. The variations in the leakage observed are mainly due to the orientation, surface area, and material of the container. These variations affect how the food inside is exposed to radiation. However, the dielectric correction ϵ*_{eff} and the reflection correction Γ* being measured as a relative term to the water model, takes care of the variations of the leakage due to the container as well as the property of the food. This makes RFTemp robust to all kinds of containers of shape and material. In FIG. 18D, the RFTemp is the container used for developing the water model as mentioned in. The performance of the system across different microwave containers is shown herein.

Distance Effect. For different distances of the receiving antenna from the microwave oven, the leakage observed varies. It is due to the path loss of electromagnetic waves. This can affect the error in leakage estimation as the above-discussed water model does not take into consideration of the path loss. Thus, to avoid this error distance bias (B_{d}) can be used:

$${B}_{d} = \frac{{E}_{d}}{{E}_{{RFTemp}^{d}}} \qquad ( 30 )$$

where E_{d} is the leakage energy due to a different position of the rx from the microwave oven and E_{RFTemp}_{^{d}} is the leakage observed at 6 cm distance (used for defining water model) measured for 15 secs. This biasing term can be set while calculating the a in Eq. 19.

$${α}^{′} = \frac{α}{{B}_{d}} \qquad ( 31 )$$

The distance biasing is a one-time thing and can be done during the installation of RFTemp. FIG. 18E shows the biasing factor for different distances.

Microwave Oven Effect. Different microwave ovens have different output power (P_{micro}) and volume capacity of heating (V_{micro}). Greater is the volume, greater is the area of heating (A_{avg}). As shown in Eq. 11, this affects the leakage observed outside the oven. Thus, to remove this error, a microwave bias (Bₘ) is defined solely depending on the microwave oven specifications. The amount of leakage escaping depends on the output power of the microwave oven and the volume of the microwave oven cavity.

$${B}_{m} = \frac{{E}_{1} \times {V}_{1}}{{E}_{{RFTemp}^{m}} \times {V}_{{RFTemp}^{m}}} \qquad ( 32 )$$

where E₁ and V₁ are the observed leakage and volume of the different microwave oven and E_{RFTemp}_{^{m}} and V_{RFTemp}_{^{m}} is the leakage and volume of the microwave oven used for defining water model. This biasing term can be set while calculating the a in Eq. 19.

$${α}^{′} = \frac{α}{{B}_{m}} \qquad ( 33 )$$

Like the distance biasing, this can be a one-time operation and can be performed during initialization. FIG. 18F shows the effect of microwave oven biasing. The grey area shows the leakage observed by the RFTemp microwave while heating 200 gm of water, that is being used for defining the water model (1000 W 1 cu. feet). The area 1804 shows the leakage observed by Microwave 1 while heating 200 gm of water (1200 W and 2 cu. feet). This high leakage can result in wrong estimations. After using the microwave biasing (Bₘ˜3), the leakage is corrected shown by the line 1802.

Sampling Effect. If there is a mismatch in the sampling rate of the receiving data, between the trained water model and the food temperature estimation phase, the area under curve calculation can be very different. For example, if the water model is trained with a sampling rate of 5 KHz and while doing food temperature estimation the sampling rate is 20 MHz, the leakage estimation will be erroneous. This error can be corrected by a sampling bias (Bₛ)

$${B}_{s} = \frac{{s}_{food}}{{s}_{wmodel}} \qquad ( 34 )$$

$${α}^{′} = \frac{α}{{B}_{s}} \qquad ( 35 )$$

where s_{wmodel} is the sampling rate used in training for the water model and s_{food} is the sampling rate used during food temperature estimation.

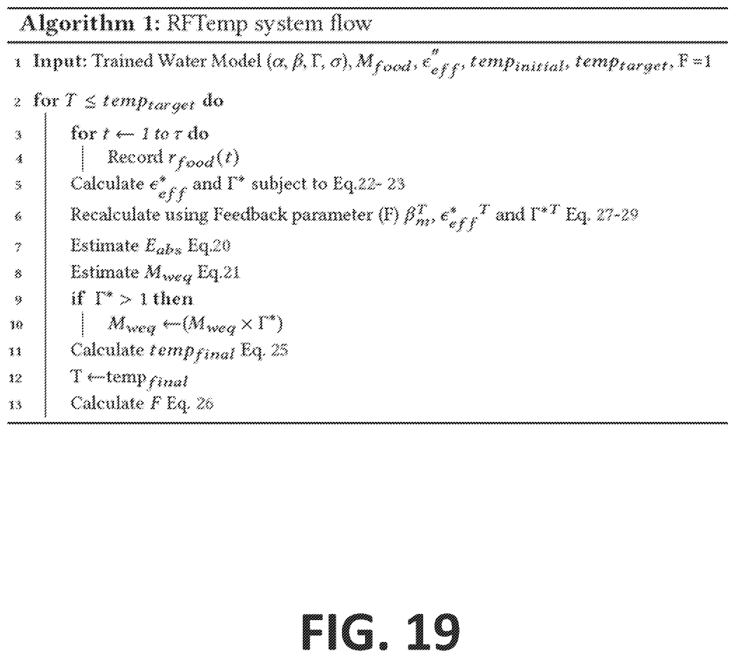

RFTemp Algorithm: FIG. 5 shows the workflow of the example RFTemp implementation. The system makes the following assumptions: 1) the mass of the food (M_{food}) is known; 2) initial temperature (temppᵢₙᵢₜᵢₐₗ) is known; 3) target temperature (temp target) is known These are realistic assumptions as most of these information are known by the user when they use microwave oven. The input mass and initial temperature of the food may or may not be accurate. RFTemp performs with high accuracy within a realistic range of input temperature and weight making the system quite flexible. The algorithm of RFTemp system flow is illustrated in FIG. 19.

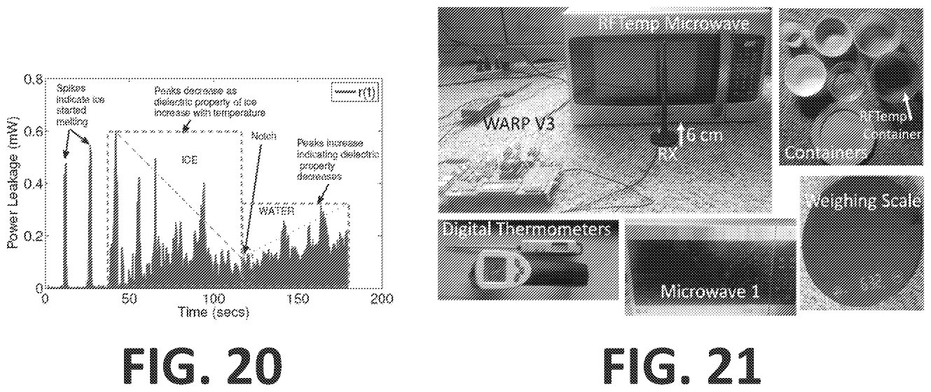

Ice has a different dielectric property compared to water. The water molecules in ice are packed tightly in a crystalline form. So they do not vibrate due to dielectric heating. Thus ice does not interact with electromagnetic radiation, and the loss factor (ϵ″_{eff}) of ice is very low relative to water. However, with the increase in temperature, the ϵ″_{eff} value of ice increases [22], thus it has a better absorbing capability, and leakage will decrease. This property is the opposite of water. This process will be dominant and continue till the ice melts off to water. Further heating will result in the water being warmed up. For water, ϵ_{eff} will decrease with temperature, so the leakage peaks will increase. This phenomenon of melting ice into water will create a notch in the leakage pattern. FIG. 20 shows the leakage pattern of 150 gram of ice heated in a microwave oven for 3 minutes. The initial spikes represent the melting phase of ice. Eq. 4 shows that, as the dielectric property increases, penetration depth increases, so the reflective power decreases. Thus with an increase in temperature, the power level of the spikes decreases. At a certain point in time, around 120 secs in FIG. 20, the leakage pattern of water. This notch represents that the ice has melted completely. RFTemp uses this sensing technique and gets water. This notch represents that the ice has melted completely. RFTemp uses this sensing technique and gets initialized after detecting the notch. The temperature of the notch is assumed to be 0° C.

To evaluate the performance of RFTemp in the real world, a prototype of the example implementation was built with a WARP v3 software-defined radio platform [9]. The carrier frequency is set to be 2.45 GHz and the bandwidth used is 20 MHz. The power leakage is measured using omni-directional antenna [12]. A down-sampler was used to process the receiving samples at 5 kHz. Experiments are performed in a household environment. The training of water model is performed using Emerson Stainless Steel Microwave oven (1.1 cu. ft, 1000 W output power) (Dimensions (Overall): 11.81 Inches (H)×21.22 Inches (W)×16.26 Inches (D)). This is referred to herein as RFTemp Microwave. A round plastic container (2 litres in max quantity) as shown in FIG. 21 has been used as RFTemp container to train the water model [7]. LMV2031SS LG Microwave oven (2 cu. ft1200 W) (Dimensions (Overall): 16.44 Inches (H)×29.94 Inches (W)×15.88 Inches (D)) has been used to verify the robustness of RFTemp across different microwaves. This is referred to herein as Microwave 1. Etekcity Infrared (IR) Thermometer 774 and Habor 022 Digital Meat Thermometer with a probe are used to measure the temperature of different foods. 10 temperature measurements were taken at different parts of the food using the probed thermometer and took the mean of them as the final measured temperature. KUBEI Digital Food Scale is used to measure the weight of different food items. Everyday household microwave containers are used to heat the food. FIG. 21 shows the setup and instruments used in this work. In all the experiments, the containers are placed at the center of the microwave oven turntable which rotates clockwise. The study evaluates the performance of RFTemp by calculating the mean absolute error between the measured temperature of the food and the RFTemp estimated temperature.

The study included verifying the operation of the example implementation. The training of the example RFTemp water model was done for weights of water ranging from 50 to 500 gm at an integral multiple of 50. For each cases, the receiver antenna (RX) was placed at 6 cm distance from the microwave oven front panel and the RFTemp container has been used as shown in FIG. 21. Parameters mentioned in herein, β, Γ, σ are calculated for the corresponding weights of water. A curve fitting algorithm with interpolation was used to make it continuous for the mentioned range of weights.

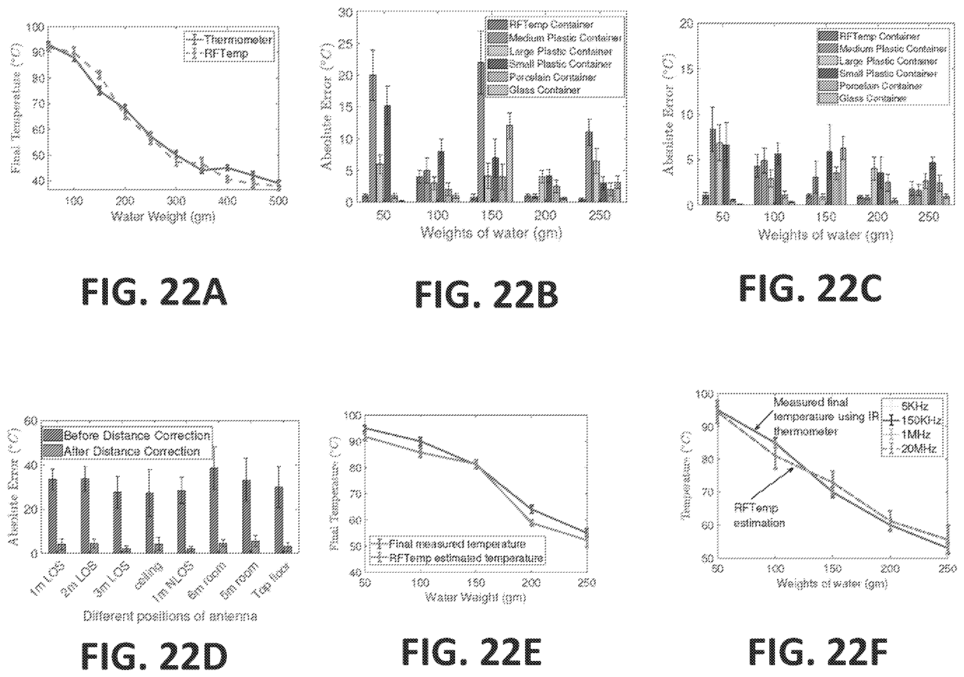

Water Model Accuracy. To verify the accuracy of the water model, the study conducted a series of experiments with the training setup shown in FIG. 21. The study heated different weights of water ranging from 50-500 gm in the RFTemp container for a 1-minute duration. The study set the dielectric correction and reflection correction parameters to 1 as, it is with respect to the same water model setup. The study repeated the experiments 10 times and measured the final temperature with the digital thermometers. It is to be noted that, RFTemp estimates the temperature every 15 secs and the estimated value is used as an input parameter for the next slot. FIG. 22A shows the mean and standard deviations of final temperature estimated by RFTemp with the final temperature measured across the different weights. The example implementation estimates quite closely as compared to the actual measurements.

Performance across Different Microwave Containers. The study verified the system across microwave containers of different shapes and materials and repeated the same sets of experiments with water 10 times. FIG. 22B shows the mean and standard deviations of absolute error between RFTemp estimations and experimental measurements of the final temperature with the dielectric and reflection correction parameters disabled. The high error is mainly because of different orientations and surface area of the containers affect the leakage as mentioned in Sec. 5.4. However, this error can be corrected easily, by enabling the dielectric and reflection correction parameters, as shown in FIG. 22C. The mean absolute error is ˜5° C. RFTemp is robust across different containers.

Performance across Different Distance. As illustrated in FIG. 18E the microwave oven leakage power decreases with distance and can require distance correction. This can result in erroneous estimations as if the distance factor has not been included in the water model.

The receiver was placed at 1 meter (m) line-of-sight (LOS), 2 m LOS, 3 m LOS, ceiling. Experiments were performed at non-line-of-sight (NLOS) positions like 1 m NLOS, inside rooms 5 m and 6 m away, and even on the top floor of the house. The study observed the power leakage of the microwave for 15 secs at these different positions and set the respective distance biases. The study then heated 100 gm of water in the microwave oven for one minute with the receiver placed at those positions. Each experiment is repeated 10 times. FIG. 22D shows the mean and standard deviation of error in RFTemp estimation before and after setting the distance correction parameter at different positions. RFTemp performs quite accurately with a mean error ˜3° C. The error value varies from 35 to 40° C. before distance correction. It is difficult to comment on if the error is directly proportional to the distance of separation. As based on the leakage, RFTemp does dielectric correction as mentioned in Sec. 5.3 that estimates the water equivalent mass. All these factors together estimate the final temperature of the food Thus the error seems to be in the same range however factors affecting it are different.

Performance across Different Microwave Ovens. To verify the performance of RFTemp for different microwave ovens, the study experimented on Microwave 1 previously mentioned. The power output is 1200 W and the volume capacity is 2 times than the microwave oven used for defining the water model (RFTemp microwave). The study calculated the microwave bias Bₘ and experimented on different weights of water for 1 minute. FIG. 22E shows the performance of RFTemp in estimating the final temperature of the food. It closely follows the measured value with a mean error less than ˜3° C.

Performance across Different Sampling Rates. To verify the robustness of RFTemp, the study performed the water model training at 5 kHz sampling rate and tested the food temperature estimation process at different sampling rates ranging from 5 kHz to 20 MHz. In this experiment the study heated 50-250 gm of water for 1 minute. The sampling bias was set each time. FIG. 22F shows the performance of RFTemp across the different sampling rates. The estimation is almost similar across different sampling rates. The mean absolute error is less than ˜3° C.

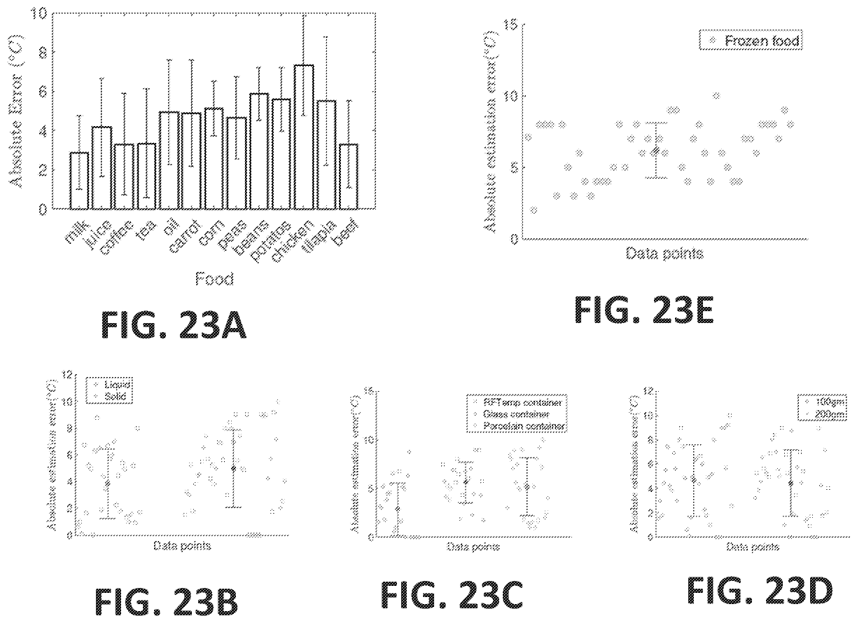

The study also evaluated the performance of the example implementation of RFTemp on different food items. The study used 13 different food items (5 kinds of vegetables, 5 kinds of liquids and 3 kinds of proteins) each of 100 and 200 gm of weight and heated them in the microwave oven for 1 minute. The study measured the final temperature of the food using both an IR thermometer and a probed digital thermometer. Due to non-uniformity in microwave heating, different parts of the food get heated differently. The study took 10 temperature measurements at different parts of the food and took the mean of them as the final measured temperature. This process was repeated for 3 different types of containers of different size and shape. The study calculated the absolute error between the temperature estimated by RFTemp and the measured final temperature to evaluate the performance of RFTemp. Since the water model has been trained for 15 secs, the system estimates the temperature of the food after every 15 secs and the estimated temperature is used as an input for the next time slot. FIG. 23A shows the performance of RFTemp across the 13 different food items. The experiments were repeated 6 times for each of the food items and the mean and standard deviation are shown. The mean absolute error for the food items is ˜5° C.

Temperature Estimation Accuracy for Different Foods: Liquid Food vs Solid Food. FIG. 23B shows the absolute error in RFTemp estimation. The study experimented on 8 different solid and 5 different liquid foods as listed on FIG. 23A. The experiments have been repeated 6 times. The circles show the absolute errors for liquid foods and the squares for the solid foods. Mean and standard deviations are shown for both the categories. For both solid and liquid food RFTemp estimates the final temperature with a mean absolute error ˜5° C. However, the example implementation performs better for liquid food than solid food which is mainly because of non-uniform heating of solid food.

Across Different Containers. FIG. 23C shows the RFTemp's performance across different containers. The scatter plots show the experiments on food under each category. The experiments were repeated 26 times under each category on the food items mentioned in FIG. 23A. The means and standard deviations are presented. The mean absolute error across different containers is around 5° C., as shown by the dotted lines. However, RFTemp container performs better (˜3° C. error) than the glass and porcelain containers (˜5° C. error). The increase in error is mainly because of slight variations in the dielectric and reflection correction as mentioned in FIG. 23C shows that RFTemp is robust across different containers.

Evaluations of the example implementation were performed. Across Different Food Weights. To evaluate the performance of RFTemp across different weights the study experimented with different food items each of 100 and 200 gm of weight. The experiments were repeated 39 times for each of 100 and 200 gm, on the food list presented earlier. FIG. 23D shows the performance of RFTemp. For both the weights RFTemp performs almost same with a mean error of ˜5° C. Thus variation of weights does not affect the performance of the example implementation of the system.

To estimate the temperature of frozen food, RFTemp is initialized by estimating the notch in the time varied power leakage pattern. To measure system performance, the study heated 7 different ready-to-eat frozen food in microwave oven and estimated the temperature at the end of 3 minutes. The study repeated the experiments 5 times on each of them. FIG. 23E shows the performance of RFTemp. The example implementation can estimate the temperature with a mean error ˜7° C. Error increases due to error in the notch detection. RFTemp can easily differentiate normal foods from the frozen foods by the initial input temperature.

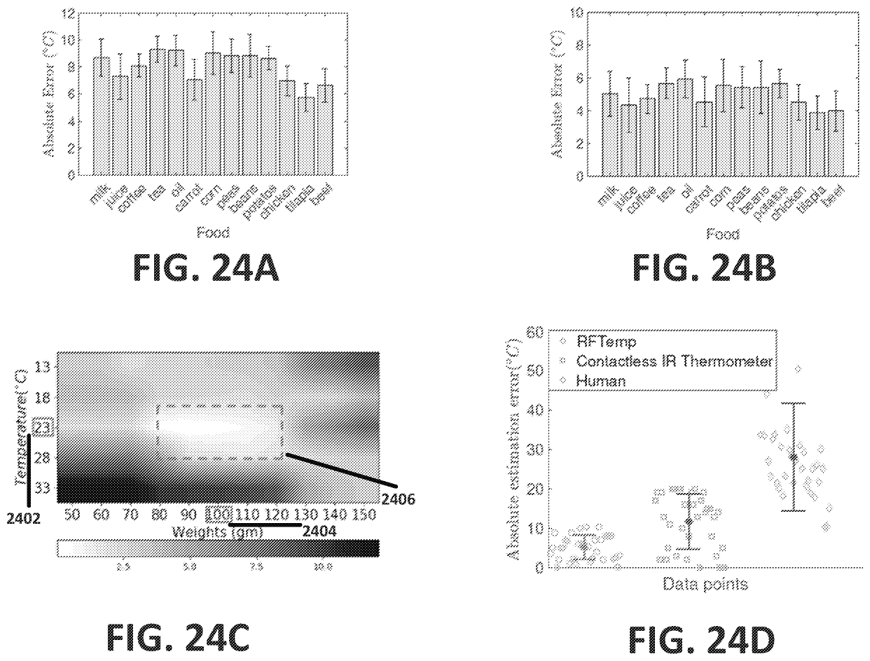

Verification of RFTemp Algorithm. To verify the performance of RFTemp algorithm, the study conducted experiments on the 13 different food items as listed in FIG. 23A for 1 minute. A random target temperature was set each time and measured the absolute error between the target temperature and the temperature when RFTemp notifies to stop the microwave oven. The experiments were repeated 6 times on each of the food items. The decision boundary was fixed at 15 secs, that is RFTemp will notify only after every 15 secs of interval. FIG. 24A shows the absolute error with 15 secs decision boundary. The mean error is ˜8° C., which is mainly because of the time slot of the decision boundary. RFTemp still estimates the actual temperature quite accurately in real time. However, due to the time slot of 15 secs, the food can get overheated compared to the target temperature. This can be more prominent on food with smaller weights as they get heated faster and there is a considerable temperature difference in consecutive slots. However, using a decision boundary of 7.5 secs, the error is reduced to ˜5° C. as shown in FIG. 24B. This can be achieved easily by training the water model for 7.5 secs. In some example implementations, further reduction of decision boundary is unrealistic as the water model will not be accurate as the increase in temperature for different weights of water during the training phase will be nominal. It is to be noted that accumulation error takes place in every time slot, however, this error is very nominal and does not affect the performance of RFTemp as shown in the FIG. 24B.

RFTemp assumes the mass of the food and the initial temperature of the food are known by the user before using the microwave oven. However, these are not hard assumptions. FIG. 24C shows the error in temperature estimation for 100 gm of water with an initial temperature of 23° C. The actual values (23 degrees Celsius and 100 grams) are marked with boxes 2402 2404, respectively. The dotted box 2406 shows the admissible errors for the range of weight and temperature values centered around the actual measured input values. For weights from 80-120 (±20 gm) and temperature 18-28 (±5° C.), the estimated errors are below 5° C. This is valid for food with any weight. Thus, even if users have a rough idea about the food weight and temperature, RFTemp can perform with high accuracy.

Across Complex Food. To evaluate the performance of RFTemp on different food items, the study conducted experiments in a household environment for a duration of 30 days. The study experimented on 35 different everyday food items of different weights and initial temperature. These food items were heated in random microwave containers for an average duration of 1-3 minutes. The study measured the final temperature using a probed food thermometer as a baseline. The study measured at different thickness of the food and estimated the average of the measurements as the final temperature. To evaluate the performance of infrared sensors and thermometers, the temperature of the food was measured in the study using a contactless IR thermometer.

The study also let the users estimate the final temperature based on their experience of microwave oven heating mechanism. The diamond points in FIG. 24D shows the human error for all the food items. The mean human error in estimation is above ˜25° C. This proves that it is not trivial for a human being to estimate the temperature of the food which results in either overheating or reheating again. The square scatter plots show the error of IR thermometer. The mean error in this case is ˜13° C. This error is mainly because IR thermometers can only pick the surface temperature rather than the actual average temperature of the food. On the other hand, the circles in the scatter plot show the performance of RFTemp on these different foods. RFTemp has the least mean absolute error of ˜5° C. among the others. Even though both RFTemp's and IR thermometer's performance is very close to one another, RFTemp performs better on solid food compared to IR thermometer. Thus RFTemp, as proposed, can estimate the temperature of the food inside the microwave oven with very high accuracy, 2× better than IR thermometers.

RFTemp Water Model Granularity, Training Period: The RFTemp water model was trained for 15 sec durations. The example implementation of the system senses leakage every 15 secs interval and estimates the temperature of the food. The 15 secs interval has been chosen because it takes around the same time for the turntable in most microwave ovens to complete one cycle of rotation. In every 15 seconds interval, RFTemp uses a feedback technique to estimate the relative parameters for the next interval. Thus, estimation errors in each section can add up in every interval. However, RFTemp can estimate the temperature with a mean error of ˜5° C. even heating food for 3 minutes. Thus the addition of error is nominal. This error can further decrease if the duration of the water model training increases as RFTemp will observe more samples to train the water model. However, there will be a trade-off as with the increase in duration, RFTemp can estimate temperature every such interval. For example, if the water model is trained for 60 secs, RFTemp will estimate temperature every 60 secs resulting in overheating as shown in FIG. 24A.

Training Weights. The water model in RFTemp is trained for food having weights of integral multiple of 50 gm between 50 to 500 gm and a curve fitting is used to estimate the parameters for intermediate weights. The training set can be improved by experimenting on weights of water with a smaller interval. The weight range is very realistic as most of the everyday food that is being heated in a microwave oven falls within that range. However, RFTemp can easily incorporate more weights by extending the training phase for higher amounts of water.

Microwave ovens are used mostly for reheating purposes. Surveys [1, 51] show that majority of the people are using microwave ovens for heating purposes for 1-3 minutes on average. However, in some cases, microwave ovens are used for thawing and cooking food. The example implementation can handle the thawing and cooking of food cases using indirect methods. Thawing is the process of ice or any frozen substance becoming liquid by getting heated [2]. RFTemp can be used for thawing purposes using the notch detection technique introduced by frozen food in Sec. 5.6. However, cooking is a more complex process that involves the change of state of water, like cooking pasta and rice in boiling water. RFTemp water model does not cover the change of state of water which involves latent heat of evaporation. Also the volume of the food changes during cooking which makes the system very complex for RFTemp to estimate. However, RFTemp can train the water model with some intelligent cooking techniques to incorporate the latent heat of evaporation of water. This has been left for future research.

For scenarios using sampling, distance and microwave biasing parameters, error accumulation in the final estimation can take place. However, such errors will be very nominal and can result in mean 1-2° C. extra error.

The present disclosure also contemplates that RFTemp can be integrated into existing systems. Microwave operates in the same frequency range as other wireless applications like WiFi. Thus the leakage from the microwave oven interferes with the WiFi communication systems. Commercial Access Point (AP) can observe the wireless activity of its channel like in [39,40] and measure the leakage due to microwave oven both in presence and absence of WiFi packet transfer and reception. Most of these commercial access points have software platforms that can be used for user-defined applications and can also forward data to the cloud or remote servers without any functional degradation [24,39]. Thus RFTemp can be easily deployed in the commercial access points using these features. During the setup phase, the initial parameters of RFTemp water model can be fed into a remote server connected with the APs. Then the empty microwave oven in the household is run for 15 secs. RFTemp running in APs can be self initialized when it detects high leakage and measures the time varied leakage and send it to the server. This is used to set up the biasing parameters as mentioned in Sec. 5.4. This is a one-time thing that is done during the setup phase. Once the setup phase is over, RFTemp can be used for temperature estimation. During heating of food, the user provides the weight of the food, initial temperature, and target temperature values to a cloud application and starts the microwave oven. APs can detect microwave leakage and forward it to the cloud server. Using the RFTemp algorithm proposed in Sec. 5.5, the cloud application estimates the temperature of the food inside the microwave oven. Once it has reached the target temperature, it can notify the user to stop further heating. It is to be noted that RFTemp deployment does not require any update on WiFi protocol and can be easily implemented in commercial APs. It also does not require any changes on the commercial microwave ovens. Thus it can be integrated into the existing systems.

Implementations of the present disclosure include RF sensing techniques to measure the temperature of the food inside the microwave oven. An example implementation was constructed and studied, and showed that the example implementation of RFTemp is robust to all varieties of food types, microwave ovens, microwave containers and can be easily integrated into the commercial systems. Thus, RFTemp can convert a commercial microwave oven into a smart microwave oven without any hardware change, which can estimate the food temperature and notify the users when the target temperature has reached, with great accuracy.

### Example 2

Food analytic and estimation of food nutrients have an increasing demand in recent years to monitor and control food intake and calorie consumption by individuals. Microwave ovens have recently replaced conventional cooking methods due to efficient and quick heating and cooking techniques. Users can estimate the food nutrient composition by using some lookup information for each of the food's ingredients or by using applications that map the picture of the food to their pre-defined dataset. These techniques can be time-consuming and not in real-time and thus can result in low accuracy. An example embodiment of the present disclosure, referred to herein as “WiNE,” includes a system that can estimate food nutrient composition and calorie content in real-time using microwave radiation. The example system monitors microwave oven leakage in the time and frequency domains and estimates the percentage of nutrients (carbohydrate, fat, protein, and water) present in the food. To evaluate the real-world performance of WiNE, a study was performed on the example system. The study included a prototype using software-defined radios and conducted experiments on various food items using household microwave ovens. WiNE can estimate the food nutrient composition with a mean absolute error of ≤5% and the calorie content of the food with a high correlation of ˜0.97.

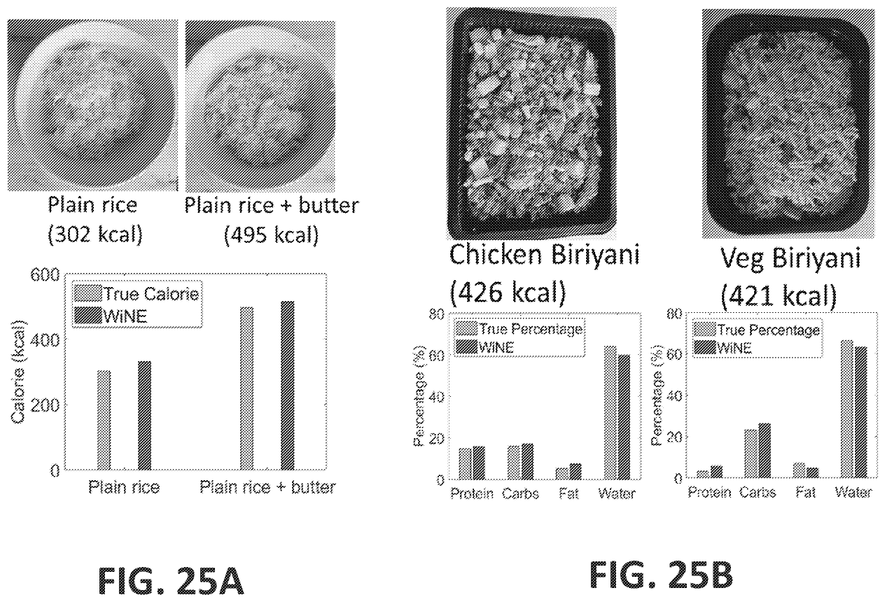

Image recognition of the food photo-based approach can be used [17-21,23,25,30-32,37,41,43,48]. Most of these works compute cross-correlation between an user-input image and a reference image. However, these techniques can be highly dependent on environments and viewpoints and can be highly erroneous if these details are not taken under consideration [38]. On the other hand, estimating the nutrient composition of food can be highly dependent on food categories, food volume, ingredients used, and cooking direction. Most of the image-recognition-based works use only food categories and food volumes to determine the food composition, often resulting in wrong estimations. FIG. 25A shows the calorie content of 250 gm of plain cooked rice (302 kcal) and the calorie content of plain cooked rice with butter (495 kcal). Even though both of these food items fall under the same food category of cooked rice, and the images can look identical, their calorie contents are quite different because of different ingredients. A photo-based approach can fail to estimate these variations correctly because they do not take the ingredients under consideration. FIG. 25B shows the calorie and nutrient proportion of chicken biriyani (426 kcal) and vegetable biriyani (421 kcal). Even though both food items fall under the same food category and have identical calorie content, their nutrient percentages are different. Chicken biriyani has high protein content and low carbohydrate (carbs) content compared to vegetable biriyani. Image-based works fail to identify these nutrient percentage variations and estimate incorrectly. This can affect individuals who want to monitor nutrient consumption rather than the calorie content. Purely photo based approaches can also be not scalable to all kinds of foods. Moreover, all these techniques are precalculated and not in real-time, making the results erroneous. Another method to automatize the food nutrient classification includes the use of hyperspectral signals to estimate the carbohydrate, fat, and protein composition of any food [15,42,49]. However, such techniques can require sophisticated instruments and are not practical in daily cooking scenarios.

An example implementation of “WiNE” (Wireless Nutrient Estimator) is shown in FIG. 6, including a wireless Radio Frequency (RF) sensing system that can monitor leakage coming out from the microwave oven window in both time and frequency domains to estimate the nutrient composition and calorie content of the food that is getting heated in real-time and calorie content.

The example implementation of WiNe includes certain features of the real-time microwave leakage sensing system, RFTemp, described in Example 1 herein.

WiNe can perform nutrient classification of the food based on its dielectric property. This technique classifies the food based on its leading nutrient and acts as an initialization process for WiNE. Additionally, WiNe can perform nutrient and calorie estimation of food, and can include a practical error correction technique that can make WiNE robust to any receiver distance and container.

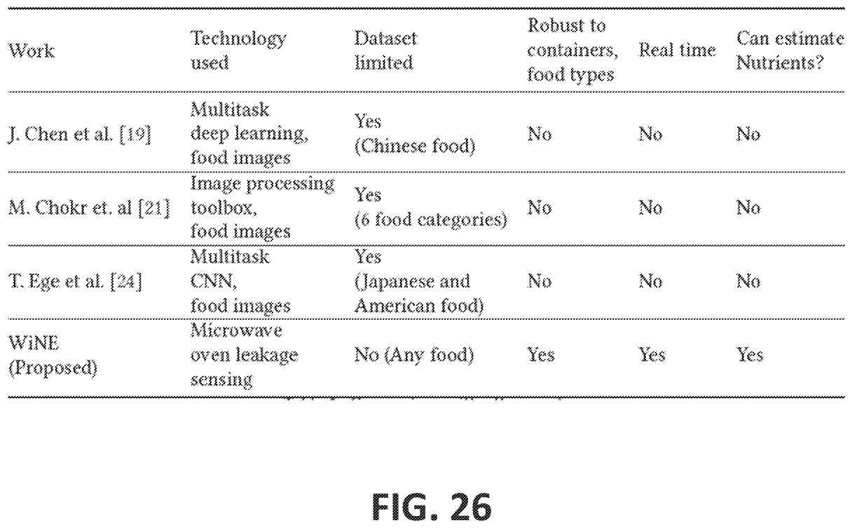

The example implementation of WiNE does not require any extra hardware installation and can be integrated easily into existing systems. FIG. 26 shows the comparison between WiNE and other methodologies.

Modern microwave ovens can operate at a frequency of 2.45 GHz with a bandwidth of only a few MHz [16, 44]. In a microwave oven, food is heated by a process called dielectric heating [12,16]. The electrically bipolar molecules of the food (like water) inside the oven absorb most of the electromagnetic radiation which causes molecular vibration which eventually results in heating the food. The important component of microwave heating is:

Permittivity: The interaction of the dielectric with the electric field is characterized by its permittivity (ϵ) The permittivity of a dielectric is expressed by Eq. 1[16,22], where ϵ₀ is the permittivity of free space and ϵᵣ is the relative permittivity of the material. The ϵᵣ is a complex term and is expressed by a real part (ϵ′) also known as dielectric constant and an imaginary part (ϵ″_{eff}) as shown in Eq. 2.

$$ϵ = {ϵ}_{0} {ϵ}_{r} \qquad ( 1 )$$

$${ϵ}_{r} = {ϵ}^{′} - j {ϵ}_{eff}^{″} \qquad ( 2 )$$

ϵ″_{eff} measures the losses when electromagnetic radiations are absorbed by the dielectric and ϵ′ determines the lossless storage and how much radiation is reflected at the surface of the dielectric [16].

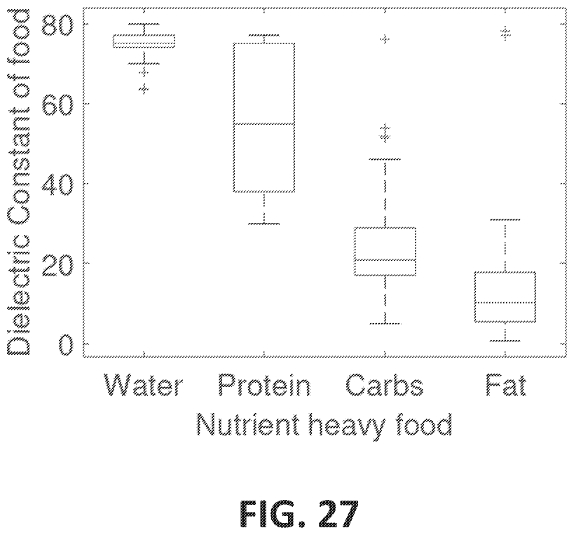

Nutrient Classification: The study shows that the dielectric property of the food can be the governing factor on how microwave radiations affect different foods. This property can be the measure of the affinity of materials to absorb high-frequency electromagnetic radiation. Food with a high amount of polar molecules has the highest ability to interact with radiations and thus has a high dielectric value. On the contrary, food with nonpolar molecules has the lowest affinity and, has low value. Thus, food with a high proportion of water has a higher loss factor and dielectric constant at 2.4 GHz and leads to faster heating [29,35]. FIG. 27 shows how different nutrient-heavy foods¹ result in different dielectric constant values. The x-axis of the figure represents nutrient heavy food

For example, a protein-heavy food has been marked as heavy food protein in FIG. 27. Thus, at 2.4 GHz frequency range, different nutrient-heavy foods (carbohydrate, fat protein, water) behave differently when exposed to electromagnetic radiations due to their molecular composition. ² This property of RF can be leveraged to classify food based on its nutrient composition.

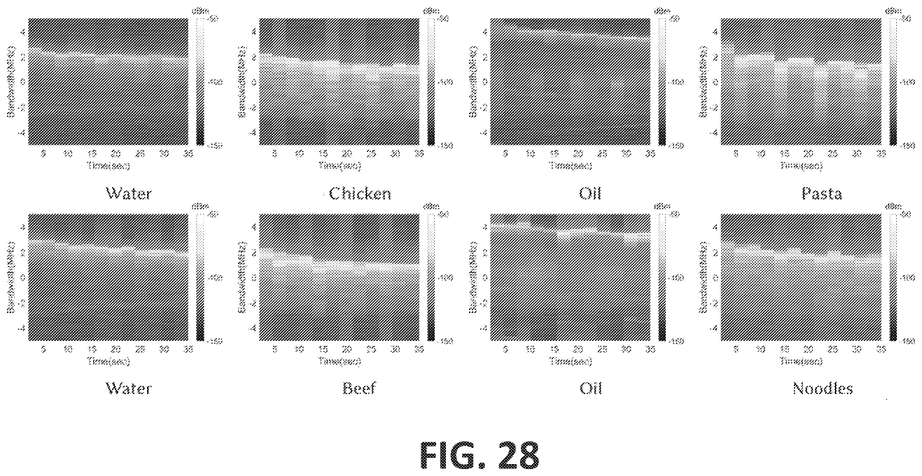

Nutrient Estimation: In the example implementation, the dielectric coefficient alone cannot estimate the nutrient composition. FIG. 28 shows microwave oven leakage spectrograms for food with different nutrient composition. The spectrogram is measured with 2.45 GHz as centre frequency and a bandwidth of 5 MHz on either side. Additionally, in the present example, w represents water, p represents protein, c represents carbohydrate and f represents fat. The percentages are true values obtained from food labels. FIG. 28 represents two different water spectrograms (water-heavy) 100% w, 0% p, 0% c, 0% f, as well as spectrogram of chicken (78% w, 20% p, 0% c, 2% f) beef (protein-heavy) (76% w, 22% p, 0% c, 2% f). Similarly two oil spectrograms (fat-heavy) (0% w, 0% p, 0% c, 100% f) are illustrated, along with a spectrogram of pasta (53% w, 9% p, 35% c, 3% f) and a spectrogram of noodles (carbs-heavy) (35% w, 0% p, 62.5% c, 2.3% f). As illustrated in FIG. 28, food with different nutrients take up different zones in the frequency spectrogram. WiNE leverages this unique feature to estimate the nutrient composition of the food.

In the present example, food with 88% water is classified as water-heavy, food with water less than 88% and protein % greater than carb and fat is classified as protein heavy. Same goes for other nutrients. The details of the classification of different nutrient-heavy food have been explained herein This figure is a simulation result based on the cumulative distribution functions described herein.

FIG. 9 illustrates a block diagram of a system for estimating the dielectric constant, that can be used as part of the system described with reference to Example 2.

Leakage Monitoring Block: This block monitors the microwave oven leakage coming out through the front panel. It is based on the idea proposed in RFTemp [16A]. However, the difference from that work is, WiNE monitors the leakage both in the time domain and time-frequency domain at the same time.

The time-domain observation helps us to set up the initialization parameter. The time-frequency domain spectrogram helps us to estimate the nutrient proportion. FIG. 31 shows the leakage for 400 gm of water.

Dielectric Constant Estimation Block: This block can be implemented using the system and method described in Example 1. The dielectric constant estimation block can also be used for the WiNe initialization scheme, using the time domain leakage observed.

To estimate the power absorption and to find a relation with the microwave oven leakage, a water model technique is applied. Based on the microwave absorption basis and experiments on water with different weights, the water model defines the following experimental parameters.

RFTemp dielectric coefficient (σ(m)): This parameter can be used to measure the experimental dielectric property of water. It is expressed as the area under the power leakage curve r(t) as shown in FIG. 31. It is an experimental measure of the food property and how well it can absorb the radiation.

$$σ ( m ) = {\sum }_{t = 0}^{τ} r ( t ) \qquad ( 3 )$$

RFTemp Relative Dielectric property of food: The dielectric constant of the food can be calculated using the following equation.

$${ϵ}_{food}^{′} = \frac{{\sum }_{t = 0}^{τ} {r}_{food} ( t )}{{σ}_{m}} * {ϵ}_{water}^{′} \qquad ( 4 )$$

where, r_{food}(t) is the leakage observed while heating the food for r=15 secs and ϵ_{water}=80. σₘ is the corresponding water dielectric coefficient, where m is the mass of water in the defined water model, closest to the mass of the food. It is to be noted that σₘ taken from the water model parameter σ(m) which consists of series of values for different weights of water. For example, σₘ represents the dielectric coefficient σ₁₀₀ for 100 gm of water.

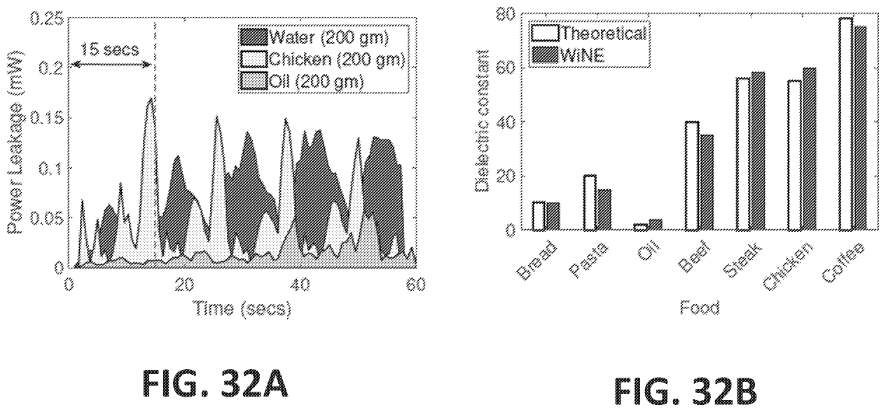

Food Dielectric Constant Block: FIG. 9 shows the workflow of the WiNE Dielectric Constant Estimation Block. Based on the RFTemp system, the study calculated σ(m) for the different weights of water ranging from 50 gm to 500 gm as the leakage pattern is different for each of them. The study calculated the parameter for the first 15 sec interval. The study used these as training set defined as WiNE Water Model in FIG. 9. Thus it is dependent on the mass of water. To verify the estimated dielectric value of food with the theoretical one, the study included experiments on water chicken, and oil, each of 200 gm heated for 1 min. FIG. 32A shows the leakage observed by water, chicken, and oil. In the first 15 secs time slot, the study shows the area under the curve of both chicken and oil is less than water. Leakage observed by chicken is around 0.7 times of water, while that of oil is 0.03 times of water. The dielectric value of chicken measured in [36A] by sophisticated cavity perturbation technique is around 55 while that of oil is around 2. Compared to the dielectric value of water (80), the dielectric property of chicken relative to water is ˜0.68 while that of oil is ˜0.025. These values closely match with the observed relative leakage values of the system (chicken—0.7 and oil—0.03). FIG. 32B shows the dielectric constant of different foods measured using the above-mentioned process. The study shows that WiNE can estimate the food property close to the theoretical values. This verifies that the design model introduced by the system accurately estimates the property of the food.

The WiNe Initialization Block can used to develop realistic initialization parameters that can help in the design of the Nutrient Estimation Block. Most of the daily consumed foods have some realistic proportion of nutrients. To study these features in more details the study included analysis of the nutrient composition of 14 k food items in My Food Data application [2A].

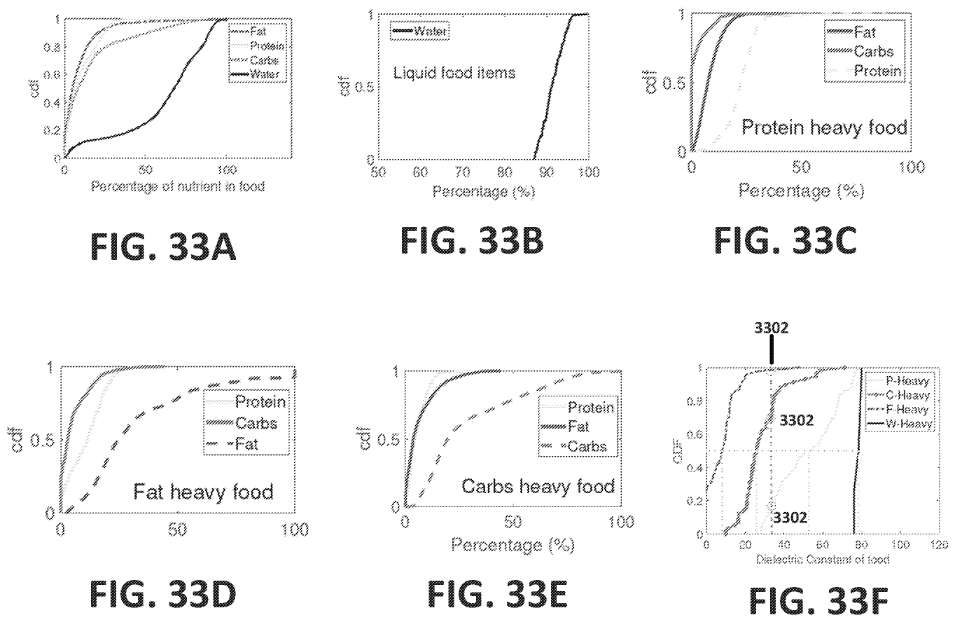

These food items include ready-to-eat foods, food items from different supermarkets and cooked food from restaurants. FIG. 33A shows the cumulative distribution function (cdf) plot of the percentage of fat, carbs, protein and water in 14 k food items. One of the observations is the mean water percentage is ˜65% for this dataset. Thus most of the food items have a large proportion of water. FIG. 33B shows the distribution function (cdf) plot of the percentage of water in liquid food items like beverage (coffee, tea, juice) and soups.

The liquid food items have a percentage of water greater than 88%. Based on this insight, the study defined this class as water heavy food having a water percentage more than 88%. Similarly the study defined food classes for other nutrients. Food with protein content higher than fat and carbohydrate and water less than 88% is defined as protein heavy food. Similar analyses were performed for carbohydrate heavy and fat heavy food. FIGS. 33C, 33D, and 33 show the cumulative percentage (cdf ˜0.5) of protein for protein heavy food class is 2× times than that of the corresponding nutrients. Similar trends are followed for fat and carbohydrate heavy food class. Thus, food with high protein content will dominate over carbohydrate and fat and should be given higher priority in Nutrient Estimation Block. This can result in benefits from classifying the food based on its nutrient composition.

Nutrient Classification Block: WiNE can estimate the dielectric property of the food, but determining the major nutrient can be a very complex and erroneous process for complex food items with various ingredients. To solve this challenge, WiNE includes a nutrient classification technique using the dielectric property of the food. The main constituents of everyday microwaved food are water, protein, fat, and carbohydrate. At the microwave frequency (2.45 GHz), these different constituents interact differently with the electromagnetic radiations. To understand the relationship between food nutrients and the dielectric property of the food, the study of the example implementation included experiments with 50 food items (the food items include ready-to-eat food, cooked and raw proteins like chicken, beef and tilapia, vegetable oils, carbohydrate heavy foods like pasta, noodles, and also liquid food items like coffee, juice, milk) of different weights. The study heated these foods in a microwave oven for 15 secs and calculated the dielectric constant by the process described herein [16A]. Using applications like [3A-5A], the study labeled these foods with the percentage of water, carbohydrate, fat, and protein contents.

Along with this, the study used the dataset provided in [7A] that contains 100 different food items with their dielectric constants and percentage of nutrient compositions. This work used a sophisticated network analyzer and coaxial probe to measure the dielectric constant of each food. Thus, these 150 food samples were used as the training dataset to understand the effect of different nutrients on the dielectric property of the food.

FIG. 33F shows the cumulative distribution function (CDF) plots of food which are protein-heavy, carb-heavy, fat-heavy and water-heavy. The light grey dotted lines (the mean value is the one corresponding to the cdf value of” 0.5) in FIG. 33F show the mean dielectric constant values of the food items. As illustrated in FIG. 33F, the mean dielectric constant is less than 10 for food items that have fat as the leading nutrient component. Similarly, the mean dielectric constant leading nutrient component. Similarly, the mean dielectric constant a for carbohydrate-heavy food is around 30, while that of protein is around 55-60. For foods that have water as the leading component has a mean dielectric value greater than 75, as shown in FIG. 33F. These cumulative distributions can be used as the classification model for WiNE. Based on this, the study can classify food based on its calculated dielectric constant (ϵ′_{food}). It is defined by K.

$$K = θ [ {f}_{w} ( {ϵ}_{food}^{′} ) , {f}_{p} ( {ϵ}_{food}^{′} ) , {f}_{c} ( {ϵ}_{food}^{′} ) , {f}_{f} ( {ϵ}_{food}^{′} ) ] \qquad ( 5 )$$

where f_{w}, f_{c}, f_{f}, fₚ are the CDFs of water, carbohydrate, fat and protein heavy food as shown in FIG. 33F, function θ returns the sorted indices of the components with the highest to lowest probabilities from the mean 0.5. For example if ϵ′_{food} is 35 as shown by the vertical black dotted line in FIG. 33F, it cuts different cdf plots at the circular points. The minimum deviation from the mean is for the carb cdf. Thus food with ϵ_{food} of 35 falls under carbohydrate heavy category. This food classification technique can be used as an initialization parameter for WiNE Nutrient and Calorie Estimation Block.

Nutrient and Calorie Estimation Block: Dielectric property is an important feature in classifying the food, however it cannot estimate the percentage of each of the nutrients in the food. To solve this challenge, the Nutrient and Calorie Estimation Block can be used by implementations of the present disclosure. This block utilizes time-frequency domain spectrogram of the microwave oven leakage. Based on the observations, the study divided the spectrogram into three broad non-overlapping divisions:

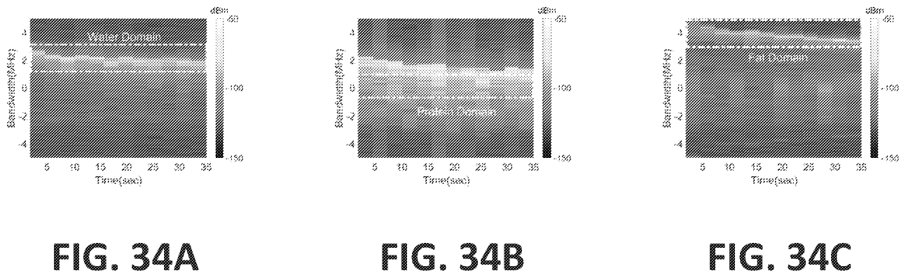

i) Water Domain: As shown in FIG. 34A, water content in the food has a trend to affect the marked frequency range in the spectrogram. The study used 10 different experimental observations of tap water of different weights to claim this fact.

ii) Protein Domain: The difference in spectrogram of FIG. 34A and FIG. 34B is due to the presence of protein in the food. As shown in FIG. 34B, protein content in the food has a trend to affect the marked frequency range in the spectrogram. The study used 10 different experimental observations to claim this fact. The study also shows some high values in the water domain in FIG. 34B due to presence of 78% water.

iii) Fat Domain: Food with 100% fat content only affects the marked spectrogram in FIG. 34C. The study defines this frequency range as the Fat Domain. The study used multiple experimental observations to claim this fact.

Based on these divisions, the example implementation can estimate the nutrient composition of the food. However, for carb heavy foods, there are no distinct non-overlapping frequency range. So the example implementation can estimate the composition of water, protein and fat only and the leftover percentage will be assigned to carbohydrate.

WiNE Training: Based on the previous observations, the example implementation includes a training set to map the spectrogram values of the nutrient domains with their corresponding percentages. To determine the relationship between the power spectrum value with the percentage of the nutrient in the food, a mapping function is defined (ϕ).

Mean (α) and max (γ) power spectrum values of the nutrient domains were used as shown in FIGS. 34A-34C as the features of the mapping model. These values were measured for 15 sec periods. The study experimented on water heavy food to define the mapping function. The study conducted 10 experiments with tap water (100% w, 0% p, 0% c, 0% f) and took the mean of the observations and defined mean (a) and max (γ_{w}) as the features for the mapping water domain. These features map the value to 100% water. To test the relationship of the spectrum variation with the percentage of water, the study experimented on different water-heavy food items (coffee, tea, milk, juice) with different water percentages and estimated their corresponding mean (α′_{w}) and max (γ′_{w}) spectrum values for the water domain:

$${P}_{γ} = {γ}_{w}^{′} - {γ}_{w} \qquad ( 6 )$$

$${P}_{α} = {α}_{w}^{′} - {α}_{w} \qquad ( 7 )$$

where P_{γ} and P_{α} are the power difference of the max and the mean spectral values of the food compared to tap water containing 100% water respectively.

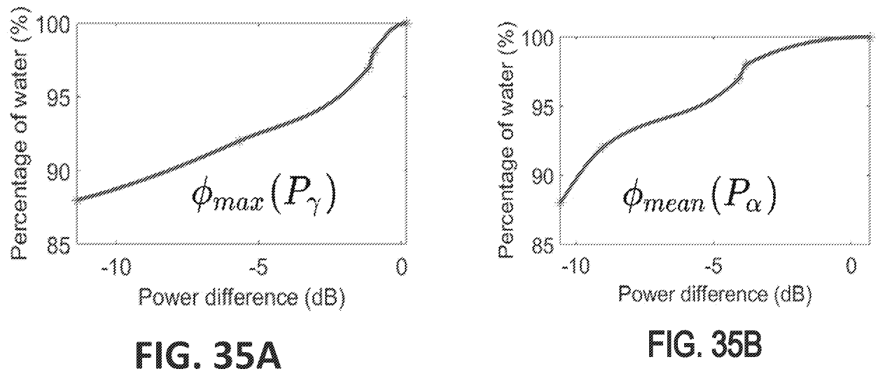

As shown in FIG. 35A, ϕₘₐₓ maps this P_{γ} to the corresponding water percentage and ϕₘₑₐₙ maps this P_{α} to the corresponding water percentage. Shape preserving interpolant was used to make the function continuous.

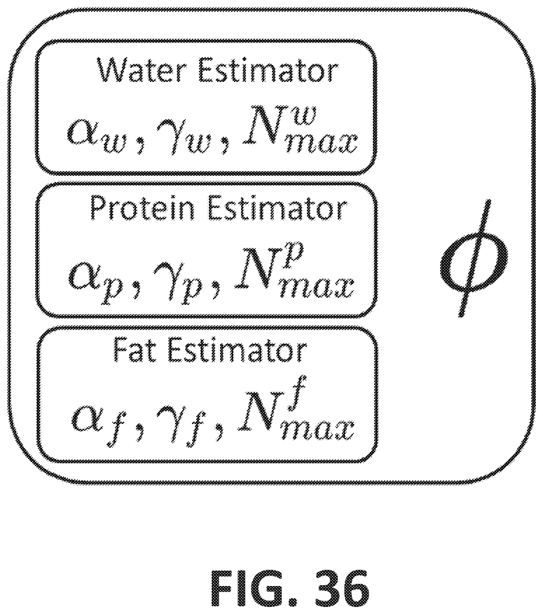

This mapping function can be independent of the nutrient type as it is measured as a function of the relative difference between the measured and the highest spectral value of the corresponding nutrient. Thus, for protein heavy food category raw beef was used as the training food. The study conducted 10 experiments with beef (77% w, 22% p, 0% c, 1% f) and took the mean of the observations and defined mean (αₚ) and max(γₚ) as the features for mapping the protein domain. These features map the value to 22% protein. Similarly for fat heavy food category the study used vegetable oil as the training food. The study conducted 10 experiments with oil (0% w, 0% p, 0% c, 100% f) and took the mean of the observations and defined mean (α_{f}) and max(γ_{f}) as the features for mapping the fat domain. These features map the value to 100% fat. Thus, the study can generalize the nutrient estimator (NE) % as:

$$NE = ϕ ( P ) / 100 * {N}_{max} \qquad ( 8 )$$

where P is the relative spectrum difference of the corresponding nutrient domain relative to its highest value and Nₘₐₓ is the corresponding nutrient's highest percentage in the training set. For example, for protein Nₘₐₓ is 22. (22% protein is the max value for about 90% of 14 k food items listed in [2A]). Thus the experimental food items cover up almost all kind of realistic protein heavy foods. FIG. 36 shows the detailed parameters of WiNE Training.

WiNE Testing: Based on the training parameters estimated in Sec. 5.4.1, a testing phase was performed to estimate the nutrient proportion of unknown food items. The power spectrum values of the unknown food (α^{food}, γ^{food}) for each of the nutrients were measured. Using the WiNE training parameters and Eq. 8 the example implementation estimated the nutrient proportion. The generalized testing phase is defined as

$${NE}^{food} = {N}_{max} / 100 * m ( ϕ ( {α}^{food} - α ) , ϕ ( {γ}^{food} - γ ) ) \qquad ( 9 )$$

where NE^{food} is the final nutrient percentage. The study took the minimum value between the estimators based on mean and max parameters. This allows for the example implementation to compensate for over estimation in some cases. It is to be noted that, Eq. 9 is repeated for each of the water, protein and fat. For simplicity a general formulation was used.

WiNE Nutrient Estimation Order: WiNE training phase only trained over corresponding nutrient heavy food. For example the water estimator can be trained for water heavy food. However, for foods which are not under the category of water heavy, this trained water estimator can result in overfitting and overestimation of water percentage. This is also same for protein and fat estimators. This can result in erroneous estimations. To solve this challenge, as mentioned in herein, the system can give priority to the nutrient that dominates in the food while doing estimation. If this priority is avoided it will result in erroneous estimation of the nutrients which in turn will result in wrong calorie calculation. The nutrient classification technique proposed in to design the priority order of estimating the food nutrients.

FIG. 10 shows the overall system design of WiNE. WiNE Initialization Block classifies the food based on its leading nutrient. Using this initialization parameter, the study can adjust the order the nutrients get estimated. For example, for water heavy food, the study estimates the water percentage first using the technique described herein with reference to the Water Estimator block shown in FIG. 10. Assume the water percentage estimated is 90%. The remaining 10% (100−90) is used for Protein Estimator block. Again, assume using the protein percentage estimation technique in to estimate 15% (which is an overestimate). The final protein percentage of the food will be 15% of the remaining 10% i.e. 1.5%. This design technique gives the corresponding leading nutrient the highest weights and reduces the overestimation error. Similar order is followed for protein and fat heavy category. Water Estimator is used as the second estimator block in both of these cases as most of the food items have large amount of water.

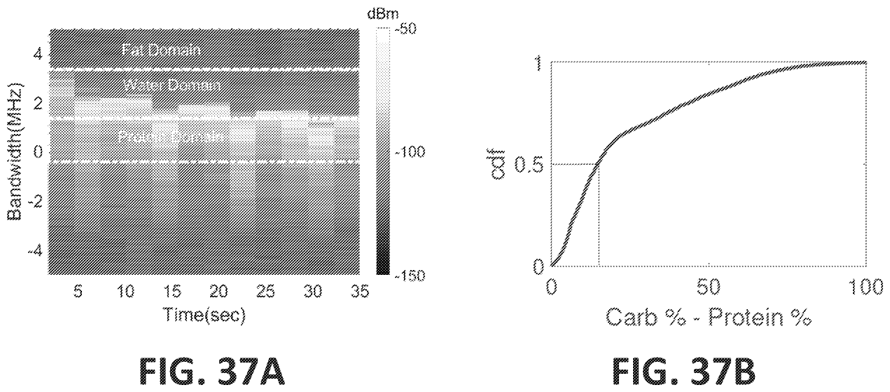

Carbs bias: Since there is no estimation technique for carbohydrate, the Carbs Estimator block can be placed at the end. However, this can result in a large error while estimating carbs heavy food. To address this, the example implementation includes carbs bias based on a realistic observation. FIG. 37A shows the spectrogram of a carbohydrate heavy food with all the defined nutrient domains marked. While estimating the nutrients, the estimated sum of protein and carbohydrate percentages follows quite closely with the true value. However without the carb bias the protein gets overestimated due to its priority and results in error in carbohydrate estimation. FIG. 37B shows the cdf of difference between the percentage of carbohydrate and protein in carbohydrate heavy food in the My Food Data [2A] dataset. As shown in FIG. 37B, the mean difference is around 12%. The example implementation uses this value as the carb bias in the system while estimating the nutrient composition of carb heavy food. Thus, while going through the Protein Estimator block the example implementation can subtract 12% from the remaining percentage after estimating water and fat percentage.

It should be understood that WiNE nutrient estimation technique estimates the percentage of each of the nutrients. Thus it is independent of the weight of the food item.

Calorie Estimator: Based on the estimated nutrient composition and the weight of the given food item the study estimated the calorie of the food using a technique [1A]:

$${F}_{c} = ( 4 p + 4 c + 9 f ) m / 100 \qquad ( 10 )$$

where F_{c} is the total calorie (kcal) of the food. p, c and f are the protein, carb and fat percentages of the food respectively and m is the mass of the food item.

Experimental error correction: As shown in the previous section, the dielectric coefficient (ϵ′_{food}) depends on the leakage observed over time, r_{food}(t). In this section, the practical experimental errors are addressed to measure the leakage and define intelligent biasing techniques to overcome it.

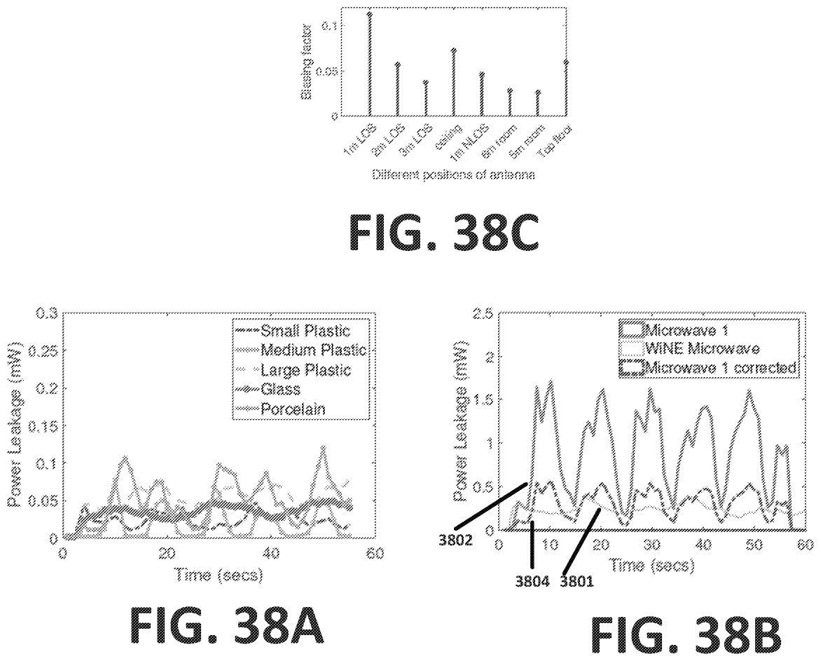

i) Container Effect: To understand the effect of containers of different shapes on the leakage observed, the study microwaved 150 gm of water across different containers for 1 minute. FIG. 38A shows that leakage pattern across different containers. The variations in the leakage observed are mainly due to the orientation, surface area, and material of the container. If these external effects are ignored, WiNE Initialization Block will estimate erroneously across different containers. To address this effect, a container bias B_{c} is used.

$${B}_{c} = \frac{{P}_{c}}{{P}_{{WiNE}^{50}}} \qquad ( 11 )$$

where P_{c} is the leakage observed while heating 50 gm of water in the new container (c), while P_{WINE}⁵⁰ is the leakage observed by heating 50 gm of water in the container used to define water model as described in Sec. 5.2. So the new leakage observed by any food in that container is calculated by

$${P}_{food} = \frac{{\sum }_{t = 0}^{τ} {r}_{food} ( t )}{{B}_{c}} \qquad ( 12 )$$

where P_{food} is the new leakage value after biasing and τ is 15 secs. The performance of the example implementation across different microwave containers is shown in Sec. 6. However, it is to be noted that the container effect is only required for the time domain WiNE Initialization block.

ii) Distance Effect: As mentioned earlier, electromagnetic radiations suffer considerable attenuation with increasing distance. Thus, if the receiver antenna is placed at different distances from the microwave oven, the leakage observed will be different. This can result in erroneous leakage estimation and thus the dielectric value estimated will be wrong. Thus to avoid this error, a distance bias (B_{d}) can be used. This biasing factor is similar to that of RFTemp, described with respect to Example 1 [16A]. The distance biasing can be a one-time operation and can be done during the installation of an implementation of the WiNE system. FIG. 38C shows the biasing factor for different distances.

iii) Microwave Oven Effect: This biasing factor can be similar to that described with reference to Example 1 [16A]. Like distance biasing, this can be a one-time thing and can be performed during initialization. FIG. 38B shows the use for microwave oven biasing. The dotted line 3801 shows the leakage observed by the WiNE microwave while heating 200 gm of water, which is being used for defining the water model (1000 W 1 cu. feet). The area 3802 shows the leakage observed by Microwave 1 while heating 200 gm of water (1200 W and 2 cu. feet). This high leakage can result in wrong estimations. After using the microwave biasing (Bₘ˜3), the leakage gets corrected as shown by the dotted line 3804.

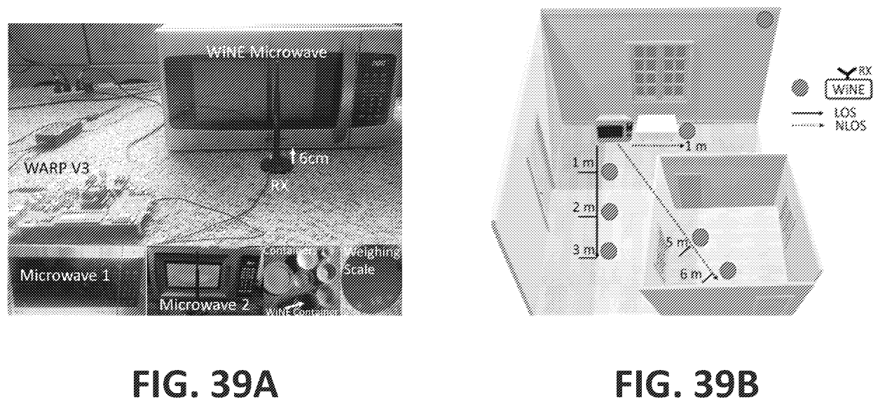

To evaluate the performance of WiNE in the real world, a prototype of an example implementation of the present disclosure was constructed with WARP v3 software-defined radio platform [10A]. The carrier frequency is set to be 2.45 GHz and the bandwidth used is 20 MHz. The power leakage is measured using omni directional antenna [14A]. A down-sampler is used to process the receiving samples at 5 kHz. Experiments are performed in a household environment. The training of the water model was performed using an Emerson Stainless Steel Microwave oven (1.1 cu. ft, 1000 W output power) (Dimensions (Overall): 11.81 Inches (H)×21.22 Inches (W)×16.26 Inches (D)). This is referred to herein as “WiNE Microwave.” A round plastic container (2 liters in max quantity) [8A] as shown in FIG. 39A has been used as WiNE container to train the water model. LMV2031SS LG Microwave oven (2 cu. ft1200 W) (Dimensions (Overall): 16.44 Inches (H)×29.94 Inches (W)×15.88 Inches (D)) has been used to verify the robustness of WiNE across different microwaves. This is referred to herein as “Microwave 1.” EM720CGA-R Mainstays Microwave oven (0.7 cu ft 700 W) has also been used. This is referred as Microwave 2. KUBEI Digital Food Scale is used to measure the weight of different food items. Everyday household microwave containers are used to heat the food. FIG. 39A shows the setup and instruments used in the study. In all experiments, the containers are placed at the center of the microwave oven turntable which rotates clockwise. The performance of WiNE can be estimated by estimating the absolute error between the estimated and true percentage of nutrients and the calorie content.

Verification of WiNE Initialization Block: The training of WiNE water model is performed for weights of water ranging from 50 to 500 gm at an integral multiple of 50. For all cases, the receiver antenna (RX) has been placed at a 6 cm distance from the microwave oven front panel and the WiNE container has been used as shown in FIG. 39A. a mentioned in is calculated for the corresponding weights of water. A curve-fitting algorithm with interpolation can be used to make it continuous for the mentioned range of weights.

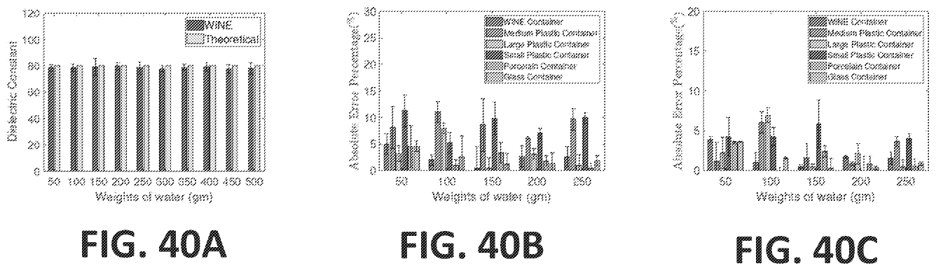

Water Model Accuracy. To verify the accuracy of the proposed Water Model described herein, the study conducted a series of experiments with the training setup shown in FIG. 39B. The study heated different weights of water ranging from 50-500 gm in the WiNE container for 15 secs duration. The study repeated the experiments 10 times and measured the ϵ′_{food} each one of them. FIG. 40A shows the average and standard deviation of ϵ′_{food} estimated by WiNE with theoretical value (80) across different weights. The example implementation estimates are close to the actual measurements.

Performance across different microwave containers. The study verified the example implementation across microwave containers of different shapes and materials and repeated the same set of experiments with water 10 times. To verify the robustness of the example implementation, the absolute error percentage was calculated, estimating the ϵ′_{food} for all weights compared to the theoretical value.

FIG. 40B shows the mean and standard deviation of the absolute error percentage between WiNE estimations and the theoretical value of the dielectric constant with the biasing factor disabled. The high error is mainly because different orientations and surface areas of the containers affect the leakage as mentioned in Sec. 5.5.

However, this error can be corrected easily by enabling the container biasing parameter B_{c}, as shown in FIG. 40C. The absolute error is less than 5% (±4 in dielectric value). This shows the WiNE water model can be robust across different containers.

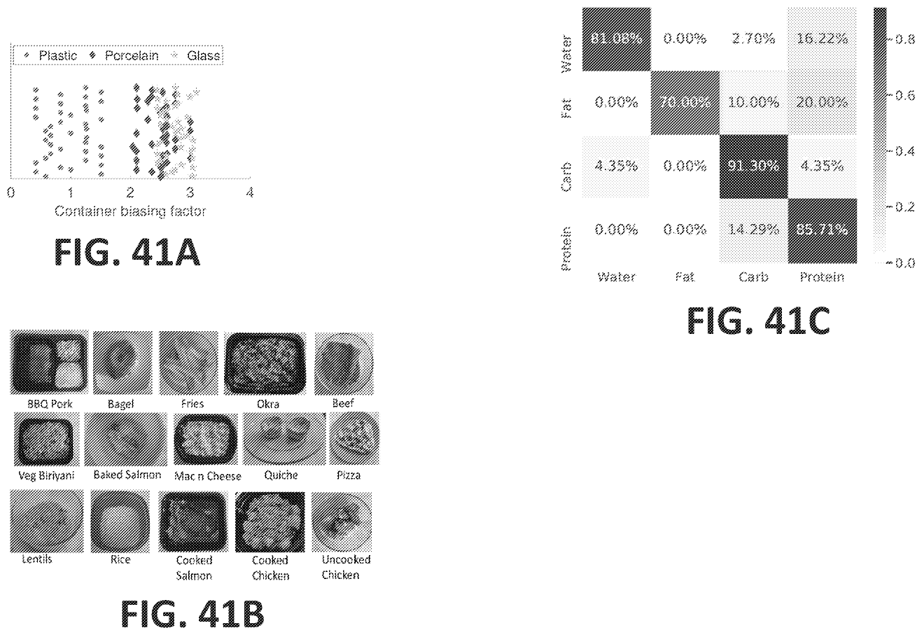

WiNE input parameters. WiNE can perform the container biasing before Initialization Block for a new container. The study calculated container biasing factors for containers of different shape and size for each of plastic, porcelain, and glass. As shown in FIG. 41A, plastic takes a value between 0.5 to 1.5, porcelain containers take a value between 2-2.5 while glass between 2.5-3. This estimation can be used directly instead of calculating the biasing factor each time for a new container. WiNE performs quite accurately with an estimated error less than 7% with these precalculated biasing factors. WiNE also assumes the mass of the food is known. This can be a realistic assumption as the mass of the food is required to estimate calorie content. WiNE also assumes the initial temperature of the food is known. However, like [16A], WiNE can perform well with low error for an approximate mass of the food (±25 gm) and an approximate initial temperature (±5° C.).

Across complex food. To evaluate the performance of WiNE on different food items, the study conducted experiments in a household environment for a duration of 30 days. The study included experiments with more than 1509 different complex food items of random weight which are heated in different microwave containers as shown in FIG. 39A. FIG. 41B shows some of the food items used. Based on the estimated dielectric constant (ϵ′_{food}), the example implementation predicted the nutrient class of the food that is being heated in the microwave oven using WiNE Nutrient Classification Block as described herein, and compared it with the actual class labels. The actual class label of the foods using smart was measured [3A-5A]. For example, chicken falls under protein-heavy food, while pasta falls under carb-heavy food. The study also evaluated the performance of WiNE using a confusion matrix as shown in FIG. 41C. The example implementation of the system accurately classifies the different classes of nutrients with a mean accuracy ˜81%.

Verification of WiNE Nutrient and Calorie Estimation Block: WiNE Testing technique as mentioned in Sec. 5.4.2 can be performed for weights of water ranging from 50 to 500 gm at an integral multiple of 50. For all cases, the receiver antenna (RX) has been placed at a 6 cm distance from the microwave oven front panel and the WiNE container has been used as shown in FIG. 39A. The study performed the WiNE initialization step as discussed herein and use the classified food category order as shown in FIG. 10 to estimate the percentage of water.

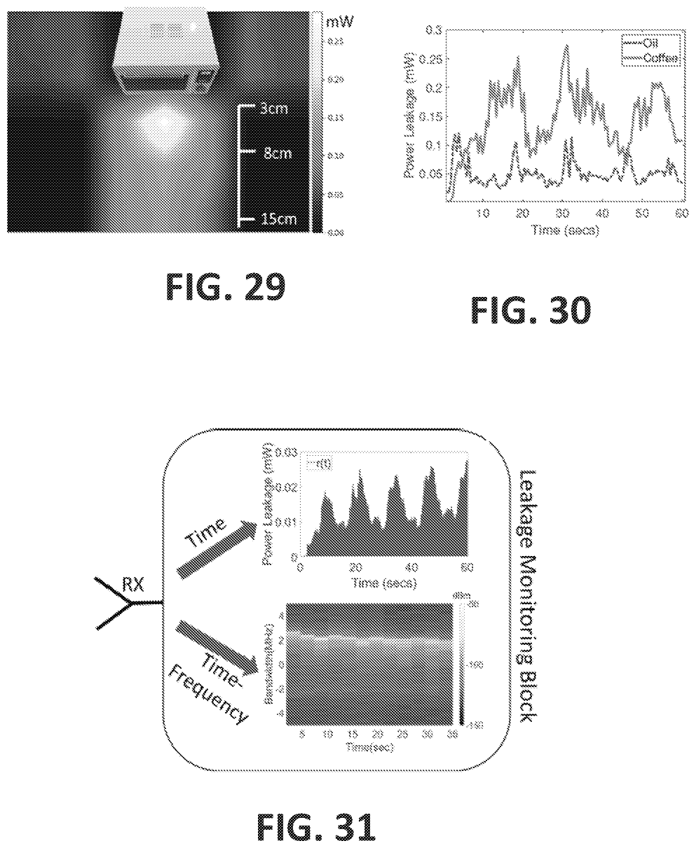

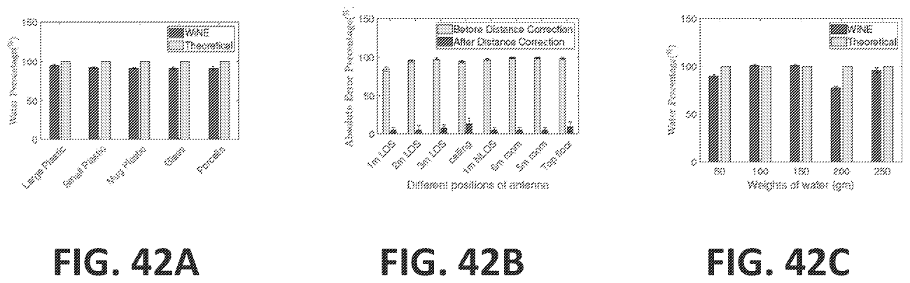

Across different biasing parameters: To verify the estimation performance of this block, the study experimented across different containers for the weights of water using the above-mentioned settings. FIG. 42A shows the performance of the estimator across different containers. FIG. 42B shows the performance before and after setting the distance biasing factor. FIG. 42C shows the performance using Microwave 1 with the biasing factor shown in FIG. 29B.

The example implementation of a WiNE Estimator block performs accurately under all variations of container, weights and distance, making the example implementation highly scalable.

To evaluate the performance of WiNE the study estimated the absolute error of the percentage of nutrient in the food and the absolute error in the calorie content. The true values of nutrients and calorie are determined using applications such as [3A-6A]

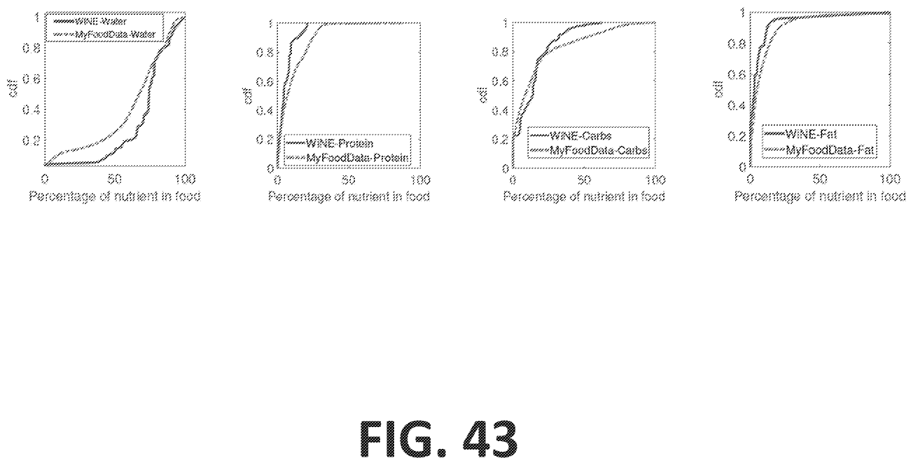

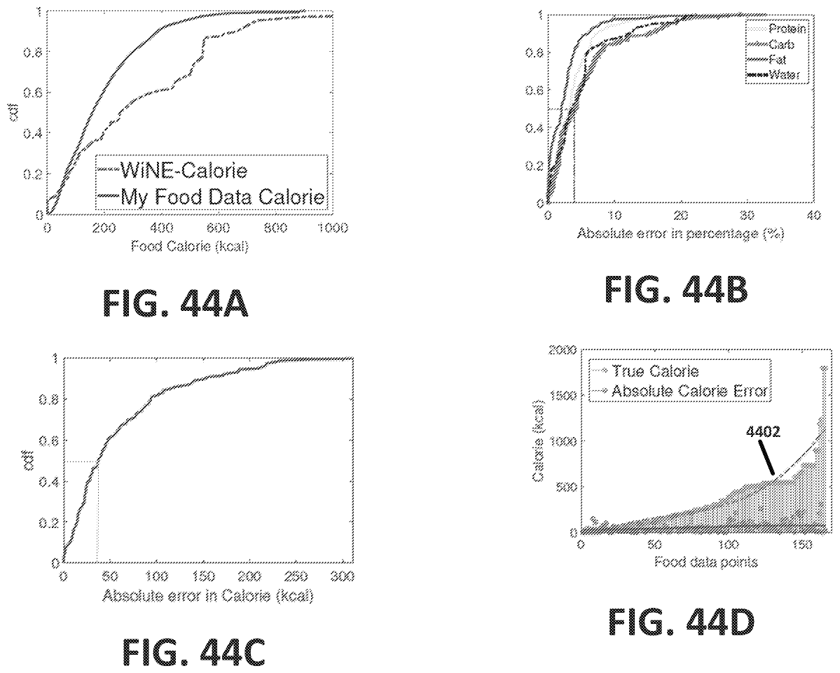

Realization of WiNE dataset: The study tested the example implementation on more than 150 different food items, from ready-to-eat, home-cooked to restaurant foods. Some of the food items are shown in FIG. 41B. The study compared the true nutrient composition of the foods in the study dataset with that of the 14 k different food items mentioned on My Food Data platform [2A]. FIG. 43 shows the cdf plot of the different nutrient percentage of the foods. The solid lines are the plots for WiNE dataset and the dotted lines are the plots for the dataset in [2A]. FIG. 44A shows the cdf plot of the calorie of the different food items in both the dataset. As shown in both figures, WiNE dataset for testing is realistic with the actual food items available in the market. Moreover, the mean calorie content in WiNE dataset is more than that of My Food Data. Thus, the performance of WiNE on various food items can easily be replicated across a large variety of food items.

Performance in Nutrient and Calorie Estimation: To evaluate the performance of WiNE the absolute error in nutrient composition and calorie content was measured FIG. 44B shows the cdf of the absolute error in percentage for each of the nutrients. The mean error is less than 5% for each of the nutrients. Carbohydrate estimation can be the worst because it is estimated at the end. FIG. 44C shows the cdf of the absolute error in calorie measurements. The example implementation can have a mean error of ˜35 kcal as shown by the grey line. In FIG. 44D, the true calorie of the food items sorted in ascending order and the corresponding absolute error are illustrated. The dotted line 4402 is used to fit the true calorie values while the solid line is to fit the calorie error. The true calorie value increases exponentially. The absolute error is more or less constant even for food with high calorific value. Thus, WiNE performs well even when the calorie content is very high.

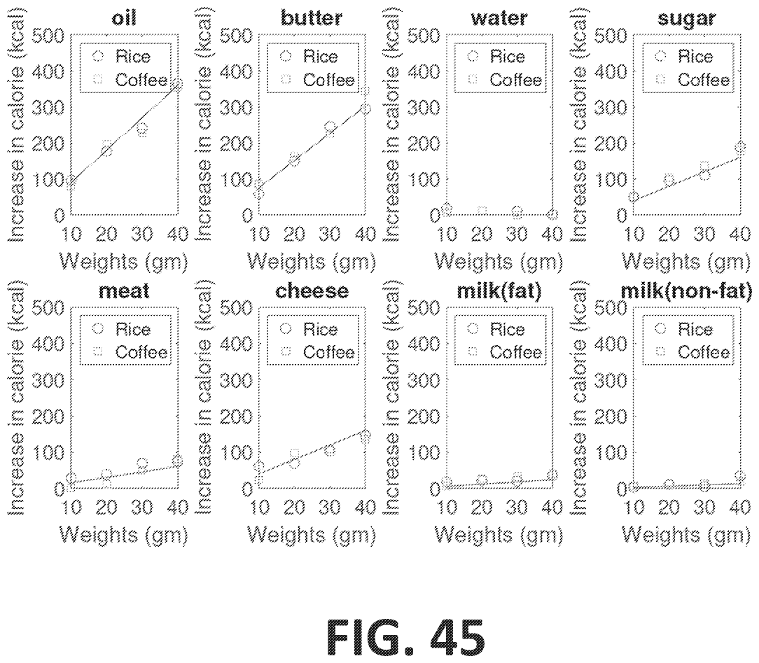

WiNE Tracking: To evaluate the validation of the WiNE Calorie Estimation technique, the study performed controlled experimentation with different food items. The study included incrementally adding 10, 20, 30 and 40 gm of oil, butter, water, sugar, meat, cheese, milk (fat) and milk (non-fat) on 100 gm of rice and coffee respectively. FIG. 45 shows the correlation plots. The solid lines show the actual increase in calorie for adding different ingredients of the mentioned weights. The circles and squares show the increase in the calorie values estimated by WiNE for the addition of ingredients to rice and coffee, respectively. For instance, adding water on rice and coffee will not increase the calorie of the food while adding butter incrementally will increase the calorie linearly. As illustrated in FIG. 45, WiNE correctly captures these variations of ingredients and correlates with the actual values.

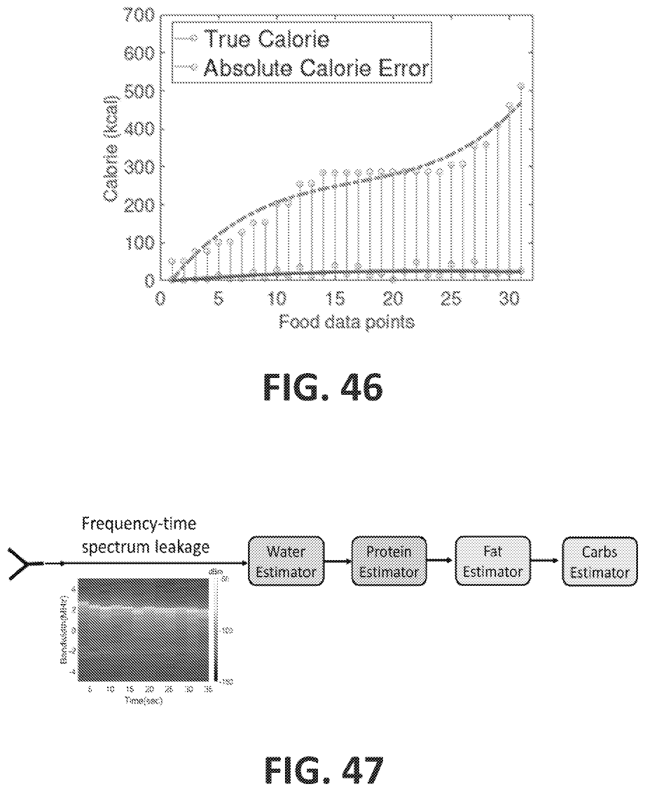

Performance across different microwave ovens: To evaluate the robustness of WiNE across different microwave ovens, the study included experiments on 30 food items across Microwave 1 and 2. The microwave biasing and frequency offset correction has been already performed. FIG. 46 shows the performance of WiNE across different microwave ovens. The performance is similar to FIG. 44D. The mean absolute error is ˜19.3 kcal. The error is more or less constant even with the increase in calorie value of the food items.

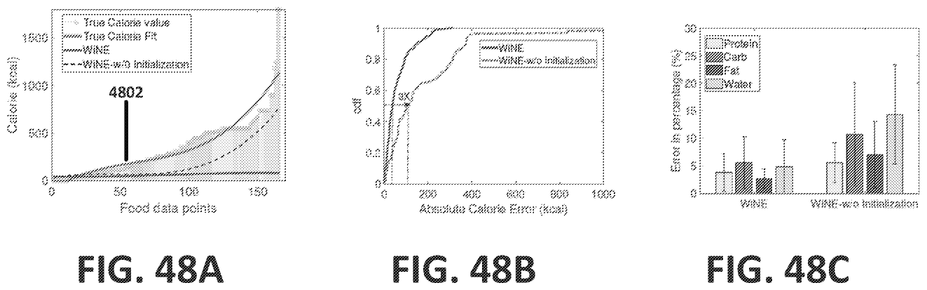

The WiNE Initialization: Block as shown in FIG. 48A-48C can be an important feature in the estimation of nutrient and calories. An experiment was performed on an implementation with the Initialization Block removed from the system design and the study estimated the nutrient percentage and calorie content for the same dataset. FIG. 47 shows the WiNE design without the Initialization Block. The example implementation followed the simplest order for the water estimator to estimate the nutrient composition.

FIG. 48A shows the performance of WiNE-w/o Initialization block. The study sorted the food in ascending order on the basis of its calorie value. The line 4802 is used to fit the true values. Similarly, the illustration uses black dotted lines to fit the absolute calorie errors for WiNE-w/o Initialization block as shown in FIG. 47. For low-calorie foods (with a high-water content) they perform quite well as WiNE. However, with an increase in the calorie value, it increases exponentially similar to the true values. WiNE performs equally well for all calorific values. FIG. 48B shows the cdf plot of the absolute calorie error for the two scenarios. WiNE-w/o Initialization degrades 3× times compared to the example implementation with initialization. FIG. 48C shows the nutrient estimation error.

The example implementation of WiNE performs better than the example implementation of WiNE-w/o Initialization. Thus, the Initialization Block can increase the accuracy of the system. component.

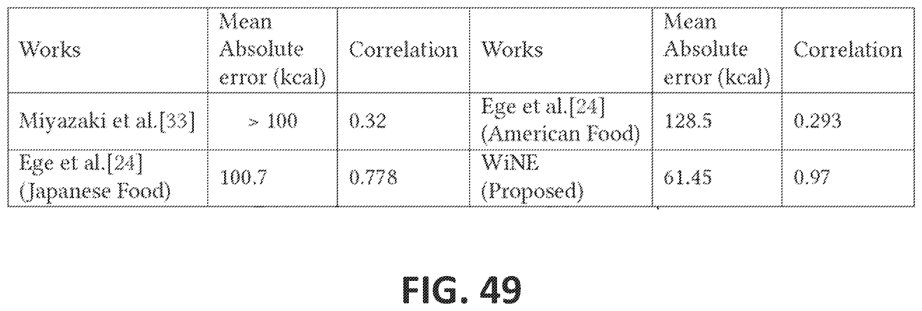

The example implementation was compared with other methodologies [24A, 33A]. WiNE enjoys a high correlation of 0.97 between the estimated and true calories of the food. FIG. 49 shows the detailed comparison.

Training period: WiNE is trained for 15 seconds (secs) in duration. That is, the example implementation system senses leakage for the first 15 seconds to estimate the proportion of nutrients. The 15 secs interval has been chosen because it takes around the same time for the turntable in most microwave ovens to complete one cycle of rotation. It should be understood that any interval of time can be used, including time intervals that are different than the turntable time interval. The mean absolute error of the system is ˜5%. The accuracy can be increased by using a longer training period. However, there will be a trade-off as the real-time estimation can be bottle-necked by the training period.

Temperature Feedback: The dielectric value is temperature dependent and decreases almost linearly with increasing temperature [16A, 27A]. Since the implementation studied measures only the initial 15 secs of leakage, the temperature factor is not required in the estimation. However, implementations can measure the leakage every 15 secs of interval with a temperature feedback block introduced in [16A] to evaluate the change in dielectric constant value.

Frozen Food: Both time-domain and time-frequency domain leakage behaves differently for frozen food as the leakage observed is because of the ice. However, this can be avoided using notch detection techniques. WiNE can be initiated when the notch is detected.

Microwave oven frequency offset: Different microwave ovens may operate at different frequency offsets (MHz) due to hardware impairments. Thus, the frequency domain spectrum of different nutrients maybe shifted in the spectrogram. Implementations can perform a correction by measuring the offset and applying a correction each time before WiNE estimation process.

Microwave oven without turntable: The example implementation used dish-rotating microwave ovens. However, for microwave ovens without a turntable can also be used. The leakage pattern may vary, however, the power leakage values for a certain duration will remain the same, or almost the same. Most domestic microwave ovens include a turntable to efficiently and quickly cook food uniformly. For that reason, the study was performed using dish-rotating microwave ovens. It should be understood that WiNE can be extended to microwave ovens without turntable.

Container bias: WiNE is verified across different containers. However, at this point of time, implementations of WiNE can require the user to input some precalculated container bias as the area under the curve as the feature to estimate the food property. Reflections from the container can affect the frequency spectrum to some extent. Implementations can remove this biasing condition using image histogram on the spectrogram [28A] and deep-neural network-based techniques [18A] by learning and estimating more features related to containers.

WiNE Nutrient Classification and Calorie Estimation: WiNE can leverage the RF properties of food nutrients (carbohydrates, protein, fat and water). With proper training of food samples, implementations of WiNe can easily estimate the effect of microwaves on fiber-rich products. Thus, with an improved classification technique and fine-grained dataset, implementations of the disclosure can quite accurately incorporate fiber-heavy foods.

Image Histogram and Deep Neural Network-based techniques: WiNE can perform nutrient estimation of food, based on microwave radiation. However, at this point of time. WiNE can improve the training by using scores of the histogram [28A] of different spectrogram images of food to learn the mapping between intensity and the nutrient percentage. Neural Network (NN) based approaches, like in works [18A, 48A] can also be built on top of WiNE to estimate fine-grained properties of food nutrients. This can include the use of intelligent data augmentation techniques proposed in work like [26A].

WiNE Deployment: The question is how WiNE can integrate into existing systems. Microwave operates in the same frequency range as other wireless applications like WiFi. Thus the leakage from the microwave oven interferes with the WiFi communication system. Commercial Access Point (AP) can observe the wireless activity of its channel like in [39A, 40A] and measure leakage due to microwave oven both in the presence and absence of transmission and reception of WiFi packets. Thus, WiNE can be deployed in commercial access points using these features.

It should be noted that WiNE deployment does not require any update to the WiFi protocol and can be easily implemented on commercial APs. It also does not require any changes to commercial microwave ovens. Thus, it can be easily integrated into existing systems.

The example implementation of WiNE includes a practical RF sensing technique to estimate the nutrient composition and calorie content of the food heated in the microwave oven. The study shows that WiNE is robust to varieties of food types, microwave ovens, and can be integrated into commercial systems. Thus WiNE provides a new domain in the nutrient estimation techniques of food in real-time. The system can convert a commercial microwave oven into a smart microwave oven without any hardware change, which can notify the user about their nutrient intake and, can aware and prevent them from serious health diseases.

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the reference list. For example, Ref. [1] refers to the 1^{st} reference in the list. All references cited and discussed in this specification are incorporated herein by reference in their entireties and to the same extent as if each reference was individually incorporated by reference.

Moreover, the various components may be in communication via wireless and/or hardwire or other desirable and available communication means, systems and hardware. Moreover, various components and modules may be substituted with other modules or components that provide similar functions.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

It should be appreciated that as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to human (e.g. rat, dog, pig, monkey), etc. It should be appreciated that the subject may be any applicable human patient, for example.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g. 1 to 5 includes 1, 1.5, 2, 2.75, 3, 3.90, 4, 4.24, and 5).

Similarly, numerical ranges recited herein by endpoints include subranges subsumed within that range (e.g. 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.
[1] 2009. Americans are eating at home more; microwave usage increases but not cooking. https://www.npd.com/wps/portal/npd/us/news/pressreleases/pr_091112/.
[2] 2013. The Big Thaw-Safe Defrosting Methods. https://www.fsis.usda.gov/food-safety/safe-food-handling-and-preparation/food-safetybasics/big-thaw-safe-defrosting-methods.
[3] 2016. Penetration Depth. https://genuineideas.com/Articleslndex/wave.html.
[4] 2017. Microwave Oven Radiation. https://www.fda.gov/radiation-emitting-products/resources-you-radiation-emitting-products/microwave-oven-radiation#Microwave_Oven_Safety_Standard.
[5] 2018. FLiR Dev Kit. https://www.sparkfun.com/products/13233/.
[6] 2019. June Intelligent Oven. https://juneoven.com.
[7] 2020. CrystalWave® PLUS 2-qt./2 L Round. https://www.tupperware.com/crystalwave-plus-2-qt-2-1-round-catalog-summer-2020/,
[8] 2020. Total unit shipments of microwave ovens in the U.S. from 2005 to 2019 (in millions). https://www.statista.com/statistics/220122/unit shipments-of-microwave-ovens/
[9] 2020. WARP Project. http://warpproject.org.
[10] 2021. Cavity magnetron. https://en.wikipedia.org/wiki/Cavity_magnetron.
[11] 2021. Dielectric heating. https://en. wikipedia.org/wiki/Dielectric_heating.
[12] 2021. VERT2450 Antenna. https://www.ettus.com/all-products/vert2450/.
[13] M. Al-Kuwari, A. Ramadan, Y. Ismael, L. Al-Sughair, A. Gastli, and M. Benammar. 2018. Smart-home automation using IoT-based sensing and monitoring platform. In 2018 IEEE 12 th International Conference on Compatibility, Power Electronics and Power Engineering (CPE-POWERENG 2018). 1-6. https://doi.org/10.1109/CPE.2018.8372548
[14] Edward Belotserkovsky, Ofer Shenfeld, and Abraham Katzir. 1994. Infrared fiberoptic temperature control of the heating process in a microwave oven. IEEE transactions on microwave theory and techniques 42, 5 (1994), 901-903.
[15] John Bows and Ketan Joshi. 1992. Infrared imaging feels the heat in microwave ovens. Physics World 5,8(1992), 21. [16] Gabe Cohn, Sidhant Gupta, Jon Froehlich, Eric Larson, and Shwetak N Patel. 2010. GasSense: Appliance-level, single-point sensing of gas activity in the home. In International Conference on Pervasive Computing. Springer, 265-282.
[17] G Cuccurullo, L Giordano, D Albanese, Luciano Cinquanta, and M Di Matteo. 2012. Infrared thermography assisted control for apples microwave drying. fournal of food engineering 112, 4 (2012), 319-325.
[18] Ashim K Datta. 2001. Handbook of microwave technology for food application. CRC Press.
[19] Abe Davis, Katherine L Bouman, Justin G Chen, Michael Rubinstein, Fredo Durand, and William T Freeman. 2015. Visual vibrometry: Estimating material properties from small motion in video. In Proceedings of the ieee conference on computer vision and pattern recognition. 5335-5343
[20] Abe Davis, Michael Rubinstein, Neal Wadhwa, Gautham J Mysore, Fredo Durand, and William T Freeman. 2014. The visual microphone: Passive recovery of sound from video. (2014).
[21] Jon E Froehlich, Eric Larson, Tim Campbell, Conor Haggerty, James Fogarty, and Shwetak N Patel. 2009. HydroSense: infrastructuremediated single-point sensing of whole-home water activity. In Proceedings of the 11 th international conference on Ubiquitous computing. 235-244.
[22] Shuji Fujita, Takeshi Matsuoka, Toshihiro Ishida, Kenichi Matsuoka, and Shinji Mae. 2000. A summary of the complex dielectric permittivity of ice in the megahertz range and its applications for radar sounding of polar ice sheets. In Physics of ice core records. Hokkaido University Press, 185-212.
[23] Sidhant Gupta, Matthew S Reynolds, and Shwetak N Patel. 2010. ElectriSense: single-point sensing using EMI for electrical event detection and classification in the home. In Proceedings of the 12th ACM international conference on Ubiquitous computing. 139-148.
[24] Milad Heydariaan and Omprakash Gnawali. 2016. WiFi access point as a sensing platform. In 2016 IEEE Global Communications Conference (GLOBECOM). IEEE, 1-6.
[25] Udo Kaatze. 1989. Complex permittivity of water as a function of frequency and temperature. fournal of Chemical and Engineering Data 34, 4 (1989), 371-374.
[26] Tareq Khan. 2018. Smart Microwave Oven with Image Classification and Temperature Recommendation Algorithm. International fournal of Electrical & Computer Engineering (2088-8708) 8,6(2018).
[27] Tareq Khan. 2018. Towards an autonomous temperature feedback microwave oven with thermal imaging. In 2018 IEEE International Conference on Electro/Information Technology (EIT). IEEE, 0444-0448.
[28] Tareq Khan. 2020. An intelligent microwave oven with thermal imaging and temperature recommendation using deep learning. Applied System Innovation 3,1(2020), 13.
[29] Christine Kuhnel, Tilo Westermann, Fabian Hemmert, Sven Kratz, Alexander Muller, and Sebastian Moller. 2011. I'm home: Defining and evaluating a gesture set for smart-home control. International fournal of Human-Computer Studies 69, 11 (2011), 693-704.
[30] Zhenfeng Li, G S V Raghavan, and Valerie Orsat. 2010. Optimal power control strategies in microwave drying. Journal of Food Engineering 99,3(2010), 263-268.
[31] Cui Liyan, Gao Min, Xiong Qingyu, Wen Junhao, and Xie Ning. 2015. Temperature monitoring based on image processing for intelligent microwave heating. In The 27th Chinese Control and Decision Conference (2015 CCDC). IEEE, 1397-1401.
[32] James Clerk Maxwell. 1873. A treatise on electricity and magnetism. Vol. 1. Oxford: Clarendon Press.
[33] Juan Monzo-Cabrera, Juan Luis Pedrefto-Molina, and A Toledo. 2009. Feedback control procedure for energy efficiency optimization of microwave-heating ovens. Measurement 42, 8 (2009), 1257-1262
[34] Ghulam Muhammad, SK Md Mizanur Rahman, Abdulhameed Alelaiwi, and Atif Alamri. 2017. Smart health solution integrating IoT and cloud: A case study of voice pathology monitoring. IEEE Communications Magazine 55, 1(2017), 69-73.
[35] T OhIsson, N E Bengtsson, and P O Risman. 1974. The frequency and temperature dependence of dielectric food data as determined by a cavity perturbation technique. fournal of microwave power 9,2(1974), 129-145
[36] OpenStax. 2020. Energy Carried by Electromagnetic Waves. https://chem.libretexts.org/@go/page/4451 [Online; accessed 2021-04-04].
[37] Shijia Pan, Mario Berges, Juleen Rodakowski, Pei Zhang, and Hae Young Noh. 2019. Fine-grained recognition of activities of daily living through structural vibration and electrical sensing. In Proceedings of the 6th ACM International Conference on Systems for Energy-Efficient Buildings, Cities, and Transportation. 149-158.
[38] Shwetak N Patel, Thomas Robertson, Julie A Kientz, Matthew S Reynolds, and Gregory D Abowd. 2007. At the flick of a switch: Detecting and classifying unique electrical events on the residential power line (nominated for the best paper award). In International Conference on Ubiquitous Computing. Springer, 271-288.
[39] Ashish Patro and Suman Banerjee. 2014. COAP: A software-defined approach for home WLAN management through an open API. In Proceedings of the 9th ACM workshop on mobility in the evolving internet architecture. 31-36.
[40] Ashish Patro, Srinivas Govindan, and Suman Banerjee. 2013. Observing home wireless experience through wifi aps. In Proceedings of the 19 th annual international conference on Mobile computing & networking. 339-350.
[41] R W Powitz. 2006. best of the best: A critical look at basic inspection tools. Foodsafety magazine (2006)
[42] Qifan Pu, Sidhant Gupta, Shyamnath Gollakota, and Shwetak Patel. 2013. Whole-home gesture recognition using wireless signals. In Proceedings of the 19th annual international conference on Mobile computing & networking. 27-38
[43] Indra Riyanto, Lestari Margatama, Hakim Hakim, Dicky Edwin Hindarto, et al. 2018. Motion sensor application on building lighting installation for energy saving and carbon reduction joint crediting mechanism. Applied System Innovation 1,3 (2018), 23.
[44] Isidro Sanchez, Julio R Banga, and Antonio A Alonso. 2000. Temperature control in microwave combination ovens. Fournal of Food Engineering 46,1(2000), 21-29.
[45] Mei H Sun, Kenneth A Wickersheim, and James Kim. 1989. Fiberoptic temperature sensors in the medical setting. In Optical Fibers in Medicine IV, Vol. 1067. International Society for Optics and Photonics, 15-21.
[46] Wei Sun, Tuochao Chen, Jiayi Zheng, Zhenyu Lei, Lucy Wang, Benjamin Steeper, Peng He, Matthew Dressa, Feng Tian, and Cheng Zhang. 2020. VibroSense: Recognizing Home Activities by Deep Learning Subtle Vibrations on an Interior Surface of a House from a Single Point Using Laser Doppler Vibrometry. Proceedings of the ACM on Interactive, Mobile, Wearable and Ubiquitous Technologies 4,3 (2020), 1-28
[47] Michael Vollmer. 2004. Physics of the microwave oven. Physics Education 39, 1 (2004), 74.
[48] Qian Wan, Yiran Li, Changzhi Li, and Ranadip Pal. 2014. Gesture recognition for smart home applications using portable radar sensors. In 201436 th annual international conference of the IEEE engineering in medicine and biology society. IEEE, 6414-6417.
[49] Xuyu Wang, Lingjun Gao, Shiwen Mao, and Santosh Pandey. 2016. CSI-based fingerprinting for indoor localization: A deep learning approach. IEEE Transactions on Vehicular Technology 66,1(2016), 763-776.
[50] Wei Wei, Akihiro Nakamata, Yoshihiro Kawahara, and Tohru Asami. 2015. Food Recognition via Monitoring Power Leakage from a Microwave Oven. Journal of Information Processing 23,6(2015), 835-844
[51] Alison Williams. 2012. Surveys of microwave ovens in US homes. (2012).
[52] Yang Zhang, Gierad Laput, and Chris Harrison. 2018. Vibrosight: Long-range vibrometry for smart environment sensing. In Proceedings of the 31 st Annual ACM Symposium on User Interface Software and Technology. 225-236.

### ADDITIONAL REFERENCES

[1A] [n.d.]. Calculate Food Calories. https://www.wikihow.com/Calculate-Food-Calories.
[2A] [n.d.]. My Food Data. https://www.myfooddata.com/.
[3A] [n.d.]. myfitnesspal. https://www.myfitnesspal.com/.
[4A] [n.d.]. mynetdiary. https://www.mynetdiary.com/.
[5A] [n.d.]. Nutrients. http://www.pomegranateapps.com/nutrients/.
[6A] [n.d.]. Yazio. https://www.yazio.com/en.
[7A] 2018. Measuring and Modelling Dielectric Properties of Food Solutions. https://ukdiss.com/examples/dielectric-properties-of-foodsolutions.php?vref=1.
[8A] 2020. CrystalWave® PLUS 2-qt./2 L Round. https://www.tupperware.com/crystalwave-plus-2-qt-2-1-round-catalog-summer-2020/.
[9A] 2020. Healthy diet. https://www.who.int/news-room/fact-sheets/detail/healthy-diet.
[10A] 2020. WARP Project. http://warpproject.org.
[11A] 2021. Diabetes. https://www.who.int/news-room/fact-sheets/detail/diabetes.
[12A] 2021. Dielectric heating. https://en.wikipedia.org/wiki/Dielectric_heating.
[13A] 2021. Obesity and overweight. https://www.who.int/news-room/fact-sheets/detail/obesity-and-overweight.
[14A] 2021. VERT2450 Antenna. https://www.ettus.com/all-products/vert2450/.
[15A] DaeHan Ahn, Ji-Young Choi, Hee-Chul Kim, Jeong-Seok Cho, Kwang-Deog Moon, and Taejoon Park. 2019. Estimating the composition of food nutrients from hyperspectral signals based on deep neural networks. Sensors 19,7 (2019), 1560.
[16A] Avishek Banerjee and Kannan Srinivasan. 2021. RFTemp: Monitoring Microwave Oven Leakage to Estimate Food Temperature. Proceedings of the ACM on Interactive, Mobile, Wearable and Ubiquitous Technologies 5, 4 (2021), 1-25.
[17A] Vinay Bettadapura, Edison Thomaz, Aman Parnami, Gregory D Abowd, and Irfan Essa. 2015. Leveraging context to support automated food recognition in restaurants. In 2015 IEEE Winter Conference on Applications of Computer Vision. IEEE, 580-587.
[18A] Nicola Caporaso, Martin B Whitworth, Mark S Fowler, and Ian D Fisk. 2018. Hyperspectral imaging for non-destructive prediction of fermentation index, polyphenol content and antioxidant activity in single cocoa beans. Food chemistry 258 (2018), 343-351.
[19A] Jingjing Chen and Chong-Wah Ngo. 2016. Deep-based ingredient recognition for cooking recipe retrieval. In Proceedings of the 24th ACM international conference on Multimedia. 32-41.
[20A] Mei-Yun Chen, Yung-Hsiang Yang, Chia-Ju Ho, Shih-Han Wang, Shane-Ming Liu, Eugene Chang, Che-Hua Yeh, and Ming Ouhyoung. 2012. Automatic chinese food identification and quantity estimation. In SIGGRAPH Asia 2012 Technical Briefs. 1-4.
[21A] Manal Chokr and Shady Elbassuoni. 2017. Calories prediction from food images. In Twenty-Ninth IAAI Conference.
[22A] Ashim K Datta. 2001. Handbook of microwave technology for food application. CRC Press.
[23A] Joachim Dehais, Marios Anthimopoulos, and Stavroula Mougiakakou. 2016. Gocarb: A smartphone application for automatic assessment of carbohydrate intake. In Proceedings of the 2nd International Workshop on Multimedia Assisted Dietary Management. 91-91.
[24A] Takumi Ege and Keiji Yanai. 2017. Image-based food calorie estimation using knowledge on food categories, ingredients and cooking directions. In Proceedings of the on Thematic Workshops of ACM Multimedia 2017. 367-375.
[25A] Takumi Ege and Keiji Yanai. 2017. Simultaneous estimation of food categories and calories with multi-task CNN. In 2017 Fifteenth IAPR International Conference on Machine Vision Applications (MVA). IEEE, 198-201.
[26A] Chao Feng, Jie Xiong, Liqiong Chang, Fuwei Wang, Ju Wang, and Dingyi Fang. 2021. RF-Identity: Non-Intrusive Person Identification Based on Commodity RFID Devices. Proceedings of the ACM on Interactive, Mobile, Wearable and Ubiquitous Technologies 5, 1 (2021), 1-23.
[27A] Udo Kaatze. 1989. Complex permittivity of water as a function of frequency and temperature. fournal of Chemical and Engineering Data 34,4(1989), 371-374
[28A] Tareq Khan. 2018. Smart Microwave Oven with Image Classification and Temperature Recommendation Algorithm. International fournal of Electrical & Computer Engineering (2088-8708) 8, 6 (2018).
[29A] V Komarov, S Wang, and J Tang. 2005. Encyclopedia of RF and microwave engineering.
[30A] Fanyu Kong and Jindong Tan. 2012. DietCam: Automatic dietary assessment with mobile camera phones. Pervasive and Mobile Computing 8,1(2012), 147-163
[3IA] Yanchao Liang and Jianhua Li. 2017. Computer vision-based food calorie estimation: dataset, method, and experiment. arXiv preprint arXiv: 1705.07632(2017)
[32A] Austin Meyers, Nick Johnston, Vivek Rathod, Anoop Korattikara, Alex Gorban, Nathan Silberman, Sergio Guadarrama, George Papandreou, Jonathan Huang, and Kevin P Murphy. 2015. Im2Calories: towards an automated mobile vision food diary. In Proceedings of the IEEE International Conference on Computer Vision. 1233-1241.
[33A] Tatsuya Miyazaki, Gamhewage C de Silva, and Kiyoharu Aizawa. 2011. Image-based calorie content estimation for dietary assessment. In 2011 IEEE International Symposium on Multimedia. IEEE, 363-368.
[34A] A Mohammadbeigi, A Asgarian, E Moshir, H Heidari, S Afrashteh, S Khazaei, and H Ansari. 2018. Fast food consumption and overweight/obesity prevalence in students and its association with general and abdominal obesity. fournal of preventive medicine and hygiene 59,3(2018), E236.
[35A] Stuart O Nelson and Andrzej W Kraszewski. 1990. Dielectric properties of materials and measurement techniques. Drying technology 8, 5(1990), 1123-1142
[36A] T OhIsson, N E Bengtsson, and P O Risman. 1974. The frequency and temperature dependence of dielectric food data as determined by a cavity perturbation technique. Journal of microwave power 9,2(1974), 129-145.
[37A] Koichi Okamoto and Keiji Yanai. 2016. An automatic calorie estimation system of food images on a smartphone. In Proceedings of the 2nd International Workshop on Multimedia Assisted Dietary Management. 63-70.
[38A] Himani S Parekh, Darshak G Thakore, and Udesang K Jaliya. 2014. A survey on object detection and tracking methods. International Journal of Innovative Research in Computer and Communication Engineering 2, 2 (2014), 2970-2979.
[39A] Ashish Patro and Suman Banerjee. 2014. COAP: A software-defined approach for home WLAN management through an open API. In Proceedings of the 9 th ACM workshop on mobility in the evolving internet architecture. 31-36.
[40A] Ashish Patro, Srinivas Govindan, and Suman Banerjee. 2013. Observing home wireless experience through wifi aps. In Proceedings of the 19 th annual international conference on Mobile computing & networking. 339-350.
[41A] Parisa Pouladzadeh, Shervin Shirmohammadi, and Rana Al-Maghrabi. 2014. Measuring calorie and nutrition from food image. IEEE Transactions on Instrumentation and Measurement 63,8(2014), 1947-1956.
[42A] Chunxiao Tang, Hayi He, Enbang Li, and Hongqiang Li. 2018. Multispectral imaging for predicting sugar content of ‘Fuji’apples. Optics & Laser Technology 106(2018), 280-285
[43A] Ryosuke Tanno, Koichi Okamoto, and Keiji Yanai. 2016. DeepFoodCam: A DCNN-based real-time mobile food recognition system. In Proceedings of the 2nd International Workshop on Multimedia Assisted Dietary Management. 89-89.
[44A] Michael Vollmer. 2004. Physics of the microwave oven. Physics Education 39, 1 (2004), 74.
[45A] Ju Wang, Xiaojiang Chen, Dingyi Fang, Jie Xiong, Hongbo Jiang, and Rajesh Krishna Balan. 2018. Material Identification and Target Imaging with RFIDs [IoT Connection]. Computer 51, 12 (2018), 64-68.
[46A] Wei Wei, Akihiro Nakamata, Yoshihiro Kawahara, and Tohru Asami. 2015. Food Recognition via Monitoring Power Leakage from a Microwave Oven. Journal of Information Processing 23,6(2015), 835-844
[47A] Alison Williams. 2012. Surveys of microwave ovens in US homes. (2012).
[48A] Jun-Li Xu, Cecilia Riccioli, and Da-Wen Sun. 2016. Development of an alternative technique for rapid and accurate determination of fish caloric density based on hyperspectral imaging. Journal of Food Engineering 190 (2016), 185-194.
[49] Dongyan Zhang, Lu Xu, Dong Liang, Chao Xu, Xiuliang Jin, and Shizhuang Weng. 2018. Fast prediction of sugar content in dangshan pear (Pyrus spp.) using hyperspectral imagery data. Food Analytical Methods 11,8(2018), 2336-2345.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for estimating a temperature change of an item in a microwave, the method comprising:
receiving item information;
receiving a trained water model;
measuring, by an antenna, an emission value from outside the microwave;
determining, a power flow into the item based on the trained water model, the item information, and the emission value; and
estimating, by the trained water model, a temperature change of the item.

2. The method of claim 1, wherein the trained water model comprises a power amplification factor, a penetration depth correction factor, a reflection coefficient, and a dielectric coefficient.

3. The method of claim 1, wherein determining the power flow into the item comprises estimating an equivalent mass of water for the item, wherein the equivalent mass of water represents a mass of water that would absorb a same amount of radiation as the item.

4. The method of claim 3, further comprising determining a reflection correction value for the item.

5. The method of claim 1, wherein determining the power flow into the item comprises estimating a power absorbed by the item based on the trained water model.

6. The method of claim 1, wherein the item information comprises a mass of the item and an initial temperature of the item.

7. The method of claim 1, wherein the trained water model comprises a power amplification factor, a penetration depth correction factor, a reflection coefficient and a dielectric coefficient.

8. The method of claim 1, further comprising modifying the trained water model based on the temperature change of the item.

9. The method of claim 1, further comprising:
receiving a target temperature, and
estimating, based on the temperature of the item, a power flow into the item, and the item information a time when the item will reach the target temperature.

10. A method for determining a nutrient content of an item heated in a microwave, the method comprising:
receiving item information
receiving a trained water model;
measuring, by an antenna, an emission value from outside the microwave;
determining an emission spectrum from the emission value;
determining, using the emission spectrum, the item information, and the trained water model, a nutrient profile of the item.

11. The method of claim 10, wherein the item information comprises a mass of the item and an initial temperature of the item.

12. The method of claim 10, wherein the nutrient profile comprises estimates of a fat percentage, a carbohydrate percentage, and a protein percentage.

13. The method of claim 10, wherein the method further comprises estimating a dielectric constant of the item.

14. The method of claim 10, further comprising estimating a calorie content of the item based on the nutrient profile of the item.

15. The method of claim 10, further comprising receiving initialization parameters representing known food compositions, and wherein determining the nutrient profile of the item is based on the initialization parameters.

16. The method of claim 10, wherein determining the nutrient profile of the item comprises applying a plurality of estimators.

17. The method of claim 16, wherein the plurality of estimators comprise water estimators, fat estimators, protein estimators, and carbohydrate estimators.
